(19) United States
(12) Patent Application Publication
(10) Pub. No.: US 2025/0217892 A1
(43) Pub. Date: Jul. 3, 2025

(54) SYSTEMS AND METHODS FOR AUTOMATING CROWDSOURCED INVESTMENT PROCESSES USING MACHINE LEARNING

(71) Applicant: The PNC Financial Services Group, Inc., Pittsburgh, PA (US)

(72) Inventors: Rajesh RAMAN, Sewickley, PA (US); Ashley Renee HALL, Abington, PA (US); Meghan SCHIFFER, Pittsburgh, PA (US)

(73) Assignee: The PNC Financial Services Group, Inc., Pittsburgh, PA (US)

(21) Appl. No.: 18/973,582

(22) Filed: Dec. 9, 2024

Related U.S. Application Data
(60) Provisional application No. 63/616,029, filed on Dec. 29, 2023.

(51) Int. Cl. G06Q 40/06; G06Q 20/10

(52) U.S. Cl. CPC G06Q 40/06; G06Q 20/102

(57) ABSTRACT

The present disclosure describes computer-implemented methods and systems for automating application processing with dynamic data collection and augmentation related to applicants' behavior. The method includes receiving a plurality of applications with corresponding information, then aggregating, storing, and preprocessing data related to the applicants' behavior. The method also includes a machine learning model including a training dataset, a feature selection module, a hyperparameter tuning module, and a prediction model. The method includes predicting the application outcome based on the application information and behavior data and generating an underwriting decision based on the prediction. The method further includes providing underwritten applications for display and receiving a selection of a subset of the underwritten applications.

### TECHNICAL FIELD

The present disclosure relates generally to machine learning-based systems and methods for automated application processing with dynamic data collection and augmentation related to applicants' behavior to provide suggested applications to users. More specifically, and without limitation, the present disclosure relates to automatically providing underwriting of applications to users, allowing users to select applications, and processing the corresponding payment and profits.

### BACKGROUND

Even though investment platforms and opportunities are easily accessible for many people, it is difficult to find platforms that offer diversified investment options. A system that provides a wide range of investment opportunities can benefit all investors using the system by easing risks and offering opportunities to achieve personal investment goals. Currently, as the number of investors increases globally, there is an increasing demand for more diversified investment opportunities to meet the needs and requirements for different and diversified investors. As a non-limiting example, small business owners may also need different categories of loans such as short-term loans to meet immediate business requirements as part of their investment options. However, the amount a small business owner may need for a short-term loan may fall below regular loan limits. Thus, the loan may be denied by a standard bank. Therefore, a small business owner with a need for a short-term loan could immediately benefit from the solutions described in the present application because the system provides a solution to allow small business owners to apply for a short-term loan outside of standard parameters. Additionally, investors may wish to diversify their investments beyond what standard banks may offer. Linking small business owners with investors can thus benefit both parties by satisfying their respective needs.

The embodiments of the present disclosure thus provide an easy-to-use opportunity to accommodate different users' needs. The embodiments of the present disclosure further incorporate modern machine learning methods to automatically underwrite and provide recommended investment opportunities and investment amounts to users, based on the behavior of applicants. The system leverages Automated Underwriting Systems (AUS), which enables lenders to process applications efficiently by generating informed decisions based on comprehensive applicants' profiles. These profiles are derived from extensive data analysis, facilitated by hybrid learning algorithms. Such algorithms are beneficial for tasks like labeling, segmentation, anomaly detection, and exploratory data analysis in underwriting processes.

Through automation, AUS processes a high volume of applications with consistency and accuracy, thereby reducing turnaround times and improving customer satisfaction. This automation not only standardizes underwriting practices but also integrates with external data sources, including credit bureaus, government databases, and online platforms, to gather comprehensive data for informed underwriting decisions.

However, AUS faces significant challenges, particularly in managing algorithmic bias and ensuring high-quality data collection. Bias in AI-driven underwriting is a critical issue, as biased models can perpetuate discrimination based on protected characteristics such as race, gender, or ethnicity. Addressing this requires meticulous attention to data quality, careful selection of features, and the application of fairness-aware machine learning techniques. The presence of bias risks adverse impacts on fairness, equity, and regulatory compliance, potentially leading to legal and reputational consequences for financial institutions. Furthermore, biased underwriting may undermine trust in these systems, from both consumers and regulatory authorities, which could perpetuate systemic inequalities and impede financial inclusion.

To counteract these biases, a multifaceted approach is essential, involving several key strategies: (1) Fairness-Aware Machine Learning: This approach integrates fairness constraints into the machine learning pipeline to promote equitable treatment across demographic groups. Techniques such as demographic parity, equalized odds, and disparate impact analysis are applied to measure and enforce fairness in underwriting decisions. (2) Bias Audits and Impact Assessments: Regular bias audits and impact assessments help detect and analyze sources of bias within AI models, evaluating how these biases might impact different demographic groups. (3) Diversity-Aware Training Data: Ensuring diversity in training data involves sourcing data from multiple providers, oversampling underrepresented groups, and, where feasible, synthesizing minority samples to strengthen model robustness. (4) Algorithmic Transparency and Explainability: Enhancing transparency through documenting model features and decision processes aids in bias detection and mitigation, using techniques like feature importance analysis and post-hoc explanations. Despite these efforts, the implementation of these strategies has yet to fully resolve bias issues. Additionally, these solutions increase both the complexity and costs of the systems.

Alongside these methods, a human-in-the-loop approach has been proposed, which incorporates human oversight within the underwriting process to complement AI-driven decision-making. In this setup, human reviewers provide feedback, review decisions, and override automated recommendations when necessary to ensure fairness and equity. However, this approach significantly increases system costs while offering limited effectiveness; relying on a small group of reviewers can introduce delays, and human biases may still infiltrate the system despite oversight measures.

In addition to standard investment opportunities such as stocks, bonds, and Exchange-Traded Funds (ETFs), the system disclosed here offers a diverse range of crowdsourced applications with detailed supporting information. The disclosed systems and methods provide users with an expanded selection of applications, including crowdsourced applications like short-term loans issued by small business owners. The disclosed embodiments incorporate advanced machine learning methods to enhance underwriting decisions, dynamically adjusting based on user feedback. These embodiments make the platform easy to use and adaptable to various users' needs.

### SUMMARY OF DISCLOSURE

Embodiments consistent with the present disclosure provide systems, methods, and devices for automatic application processing.

The embodiments of the present disclosure describe computer-implemented systems and methods for performing automatic application processing. Some disclosed embodiments relate to software applications for using comprehensive applicant behavior analysis for processing of a financial product application. Some embodiments may provide a user interface allowing a user to select a financial product, provide funding, and receive payments. Some embodiments provide a user interface allowing a user to adjust the application processing.

For instance, a user may plan to provide funding for a loan application under $30,000 for a small business in the food industry. Based on the user's request and preferences, the system may provide options to the user based on evaluation and approval of the applicants' financial and social behavior. In some embodiments, the system may use historical applications data to adjust the outcome of the application processing.

Some embodiments involve a non-transitory computer readable medium containing instructions that when executed by at least one processor cause the at least one processor to perform receiving a plurality of applications with their applicants' information, obtaining a plurality of web site addresses for electronic resources related to the applicants' behavior, aggregating and storing content data corresponding to the applicants' behavior into the applications data, receiving the plurality of applications data comprising aggregated information, preprocessing the plurality of applications data by normalizing the data for input into a machine learning model, inputting the preprocessed data into the machine learning model wherein the machine learning model may include a training dataset including applications data, underwriting decisions, financial gain, and user-provided feedback from a plurality of previously approved applications. The machine learning model may include a feature selection module configured to: receive a plurality of candidate features associated with the applicant's behavior; analyze the candidate features to determine their weight, wherein the feature weight indicates the predictive value of each feature with respect to a target outcome; select, based on the feature weight, a subset of features that maximizes model performance. The machine learning model may include a hyperparameter tuning module configured to: automatically generate a set of hyperparameters, define a search space of candidate hyperparameters and associated ranges based on model requirements and training data and iteratively adjust the hyperparameters using a tuning strategy. The machine learning model may include a prediction model configured to compute an expected application outcome score. Some embodiments involve a non-transitory computer readable medium containing instructions that when executed by at least one processor cause the at least one processor to perform computing a score for each of the plurality of applications based on the expected outcome score and based on a comparison of the expected performance score of one or more predefined thresholds to generate an underwriting decision, providing the plurality of applications for display with the associate application data on a device associated with the user if the underwriting decision is approved, and receiving a selection of the plurality of applications from the user.

Aspects of the disclosed embodiments may include tangible computer readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

Throughout this disclosure the phrase “disclosed embodiments” refers to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic. It is to be understood that both the foregoing general description and the following detailed description are exemplary and explanatory only, and are not restrictive of the disclosed embodiments, as claimed.

### BRIEF DESCRIPTION OF DRAWINGS

Embodiments and various aspects of the present disclosure are illustrated in the following detailed description and the accompanying figures. Various features shown in the figures are not drawn to scale. Identical reference numerals generally represent identical components in the exemplary implementations of the present disclosure.

FIG. 1 is a schematic diagram of an exemplary system for an automatic application processing, consistent with disclosed embodiments.

FIG. 2 is a schematic diagram of the exemplary system for automatic application processing with data collection corresponding to comprehensive analysis of the applicants' behavior, consistent with disclosed embodiments.

FIG. 3 is a flowchart of an exemplary method for performing an automatic application processing, consistent with some disclosed embodiments.

FIG. 4 is a diagram showing an example of fund transfer, consistent with some disclosed embodiments.

FIG. 5 is a diagram showing an exemplary process of the machine learning models, consistent with some disclosed embodiments.

### DETAILED DESCRIPTION

Reference will now be made in detail to exemplary embodiments, examples of which are illustrated in the accompanying drawings. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently. Reference will now be made in detail to the disclosed embodiments, examples of which are illustrated in the accompanying drawings.

Disclosed herein are systems, methods, and non-transitory computer readable media relating to automated application processing with dynamic collection and augmentation of data related to applicants' behavior. Some disclosed embodiments involve a non-transitory computer readable medium storing a set of instructions. The non-transitory computer readable medium refers to any type of physical non-transitory computer readable medium on which information or data readable by a processor can be stored as described and exemplified elsewhere herein.

In some disclosed embodiments, instructions are executed. Instructions refer to a set of commands or orders that are capable of being interpreted and executed by a processor. This execution refers to the process of carrying out commands by a computer or a processor as described and exemplified elsewhere herein.

Some disclosed embodiments involve at least one processor. A processor refers to any physical device or group of devices having electric circuitry that performs a logic operation on an input or inputs, as described and exemplified elsewhere herein. A processor may perform operations by taking one or more actions for carrying out or accomplishing an action, task, or function, such as taking actions disclosed herein.

Some disclosed embodiments involve performing data transfer by at least one processor using a non-transitory computer readable medium associated with an automated electronic system. Data transfer refers to the process of copying data from one location to another. The transferred data may be transformed in transit or arrive at its destination as-is. For instance, data transfer from a remote server to a local computer, memory to memory, register to register, memory to register, or register to memory, and/or any other data transfer.

In some disclosed embodiments, individualized data transfer may be performed by the at least one processor using a non-transitory computer readable medium associated with an automated electronic system. Individualized refers to adapting to the needs or special circumstances of an individual. Individualized overlapping data transfer refers to a method or approach where each data transfer operation may be managed or optimized individually to maximize efficiency and reduce latency.

Some disclosed embodiments involve applications. An application refers to a formal request or submission for a specific purpose, often accompanied by relevant information or documentation. For instance, a job application or a loan or insurance application submitted by an individual or business for assessment. An application contains essential data (application data) such as identification information, financial and social behavior data, and personal demographics. The automated underwriting system processes this information using algorithms and machine learning models to evaluate the applicant's profile and determine approval, interest rates, or other conditions.

Some disclosed embodiments involve an applicant. An applicant refers to an individual or entity that submits a formal request or application for a specific purpose, often seeking approval, funding, or admission. By way of example, an applicant refers to the individual or business entity that submits a request for financial products or services, such as a loan, credit card, or insurance policy. Applicants may provide personal, financial, and behavioral information to the system, which may then be used as input for the machine learning model within the AUS. Applicants may be one or more individuals, business owners, shareholders and the like.

Some disclosed embodiments may involve a non-transitory computer readable medium containing instructions that when executed by at least one processor cause the at least one processor to perform receiving a plurality of applications with their applicant's information wherein the applicants input the information. For instance, an applicant such as a businessowner, may apply for a loan to purchase new equipment that will improve production capacity of the business. The applicant provides identifying information to the system disclosed herein that identifies the shareholders and decision makers in the business and the area in which the business operates. The identifying information may include name, social security number, local and federal business permit and the likes. All the essential identifying information may be provided by the applicant. The at least one processor may store all the identifying information that is input by the applicant into the application information.

Some disclosed embodiments involve financial products. A financial product refers to any financial asset, service, or instrument offered by financial institutions to meet the varied needs of consumers. Financial products encompass a broad range of offerings, including loans, credit lines, insurance policies, and investment accounts, each structured to provide specific financial benefits or solutions. In the field of AUS, financial products are evaluated and customized based on applicants' profiles, enabling tailored risk assessments and personalized terms. Common financial products in AUS might include personal loans, mortgage financing, and business credit lines. These products are essential for supporting diverse financial goals while managing risk, as the AUS analyzes applicant data to determine eligibility and establish appropriate terms. Financial products may be categorized as credit products (e.g., personal loans, credit cards), investment products (e.g., mutual funds, retirement accounts), or insurance products (e.g., life insurance, property insurance). Financial product customization, in this context, refers to the process of adjusting product attributes—such as interest rates, credit limits, or coverage levels—based on applicant data. This customization allows AUS to enhance product accessibility while maintaining accuracy in risk assessment and decision-making.

Some disclosed embodiments may involve a non-transitory computer readable medium containing instructions that when executed by at least one processor cause the at least one processor to perform obtaining a plurality of website addresses for electronic resources related to an applicant seeking a financial product. For instance, upon entry of the applicant's information into the application, the processor retrieves a list of website addresses that contain electronic resources with relevant information about the applicant. For a business owner in the food industry, this could include electronic resources that provide insights into business performance. In addition to credit agency sites and financial records, verification sites, government registries, tax portals, public platforms, and social media can offer valuable information about the business's success and trajectory.

Some disclosed embodiments involve website address for electronic resources. A website address, also known as a URL (Uniform Resource Locator), may be a specific digital location on the internet that directs users to a particular webpage or online resource. Website addresses may be essential in providing access to digital content, services, and information, serving as the entry points to a vast array of online resources. Within AUS systems, website addresses may be used to retrieve real-time data from trusted sources, enhance identity verification, or access financial databases relevant to applicant profiles. Common website addresses in AUS might include credit bureaus, financial news portals, and regulatory databases. These addresses may be used for obtaining up-to-date and reliable information, which supports informed decisions and assessment. Website addresses may be categorized by function, such as data sources (e.g., credit agency sites, financial records), verification sites (e.g., government registries, tax portals), or applicant-submitted URLs (e.g., business websites). Address validation, in this context, refers to the process of verifying the legitimacy and security of website addresses, ensuring the data retrieved aligns with the standards of accuracy, relevance, and privacy required for AUS processes.

Some disclosed embodiments involve social media. Social media refers to online platforms and applications that enable users to create, share, and interact with content and connect with others. Social media allows for the exchange of information, ideas, personal stories, and multimedia in real-time, facilitating communication and community-building across diverse user groups. Common social media platforms may include FACEBOOK, X, INSTAGRAM, LINKEDIN, and TIKTOK, each serving different forms of content sharing, such as text, images, videos, and live streaming. In addition, public discussion forums and online communities are types of social media where users engage in open conversations. Public discussion forums can serve as a valuable source of unstructured text data for analyzing applicant behaviors, industry trends, or business reputations. Within AUS, social media data can provide additional insights into user behavior and preferences. Machine learning algorithms may analyze social media data-such as public profiles, business activity, or user engagement patterns—as supplementary information to help assess creditworthiness. Social media data can also be leveraged to identify trends, gauge sentiment, or detect fraud. Social media insights may enhance the understanding of certain applicant types, such as small business owners, by analyzing social proof, business interactions, and customer feedback. Social media data may contribute to a more comprehensive profile and support personalized recommendations within AUS. By way of example, business profiles on LINKEDIN may be used as supplementary data for assessing small business loans. By way of example, sentiment analysis on platforms like X and REDDIT, may be used to understand brand perception or consumer sentiment about an applicant's business.

Some disclosed embodiments involve data types such as image, text, and video. Data types represent the different formats in which information may be stored, processed, and analyzed. Image, text, and video may be among the most common data types, each with unique characteristics and challenges for analysis and modeling. Text data refers to unstructured data that consists of words, phrases, sentences, or entire documents. In machine learning, text data may be used in applications such as natural language processing (NLP), sentiment analysis, and topic modeling. Text data can be obtained from multiple sources like social media posts, product reviews, financial documents, or chat logs. Image data may consist of visual information captured as pixels, which may be processed by computer vision models to recognize objects, patterns, or text within images. Image data may be used in facial recognition, medical imaging, and product classification. within AUS, image data might be used for document verification (such as ID or financial document scans) or assessing a person's behavior. For instance, the applicant may post images on his/her social media demonstrating gambling in a casino. The images may suggest unreliable behavior in terms of unstable financial priorities.

Techniques such as convolutional neural networks (CNNs) may be applied to image data to extract meaningful patterns for decision-making. Video data may comprise a sequence of images (frames) over time, capturing dynamic content and movement. Video analysis is complex and may involve tasks like object tracking, activity recognition, or scene understanding. Within AUS, video data could support identity verification (for instance, live video for verifying identity during online applications) or unreliable behavior. Video processing in machine learning requires computational resources and may be applied with models that handle temporal data, like recurrent neural networks (RNNs) or long short-term memory networks (LSTMs), for sequential analysis. Each data type may require different processing techniques and algorithms to maximize its value in automated decision-making and underwriting processes.

Some disclosed embodiments may involve a non-transitory computer readable medium containing instructions that when executed by at least one processor cause the at least one processor to perform aggregating and storing content data corresponding to the applicants into the applications data. For instance, the aggregation process may include mapping disparate data formats, such as reviewing texts and images. Once the data is aggregated, the system may organize and store it as part of the application data to facilitate downstream processes.

For instance, the user generated content on public platforms contains information on success of the business applying for the loan application. The information may be obtained from the clients' reviews on the range of the business products. The data may include the business owners' social behavior such as any potentially unreliable behavior or their way of communication with their competitors and the clients. The information related to the applicant may be aggregated and stored into the database containing application information.

Some disclosed embodiments may involve a non-transitory computer readable medium containing instructions that when executed by at least one processor cause the at least one processor to perform receiving the plurality of applications data comprising aggregated information corresponding to the applicants. For instance, within the system disclosed herein the identifying information entered by the applicant may be aggregated with the information obtained from the public electronic resources, such as social media and public criminal history. For instance, during this step the name and financial information of the business, the applicant, may be aggregated with the business owner social behavior and stored as the application information.

A database refers to a structured collection of data that may be stored and managed to allow easy access, retrieval, and manipulation. Databases may serve as repositories for various types of information and are designed to efficiently store, organize, and retrieve data. They may range from simple spreadsheets to complex systems supporting large-scale applications. In AUS, databases hold data that the system uses for analysis and decision-making. These databases may contain a wide variety of data, such as credit scores, transaction histories, demographic information, and other details that are relevant to assessment. In AUS, databases also often integrate with external sources like credit bureaus, government registries, and other third-party providers to ensure comprehensive data coverage. Learning algorithms rely on data from these databases to learn patterns, make predictions, and generate insights that enhance the underwriting process. Databases in AUS are typically structured to ensure data integrity, security, and compliance with regulations, as they handle sensitive financial and personal data. By way of example, database may be customer information databases that store applicant details; transaction databases that log spending patterns, payment history, and financial transactions; and/or credit bureau databases that integrate external credit scores and public records to provide a broader picture of an applicant's financial status.

Some disclosed embodiments may involve a non-transitory computer readable medium containing instructions that when executed by at least one processor cause the at least one processor to perform preprocessing the plurality of applications data by normalizing the data for input into a machine learning model. For instance, the identifying and financial information of the applicant may be aggregated with the business owner social behavior. The social behavior of the applicant may be aggregated with information from the public electronic sources. The social behavior information may contain images, videos and texts contents that needs to be preprocessed to the normalized data structures that enter the machine learning environment.

Some disclosed embodiments involve preprocessing data. Preprocessing data refers to the process of cleaning, transforming, and organizing raw data to make it suitable for machine learning models. This step may prepare data for analysis, ensuring that the model receives consistent, relevant, and high-quality input, which can enhance model accuracy and reliability. In AUS, preprocessing data may ensure that applicant information may be accurately interpreted by the model. Data collected from various sources may contain inconsistencies, missing values, or outliers, and preprocessing addresses these issues through various techniques. Preprocessing steps may include handling missing values (e.g., filling in or discarding incomplete data), normalizing or standardizing data (scaling numerical values to a common range), encoding categorical variables (converting non-numeric values into a numerical format), and removing outliers (eliminating data points that fall outside the expected range and could skew results). Preprocessed data allows the AUS to produce unbiased predictions on approvals, and creditworthiness for applicants. ML inputs are preprocessed to ensure consistency and may undergo techniques like scaling, encoding, or normalization before they are fed into the model. In AUS, these preprocessed inputs allow the system to generate predictions about an applicant's degree of uncertainty, or eligibility, all of which support more informed and efficient underwriting decisions.

Some disclosed embodiments involve normalizing data. Normalizing data refers to adjusting data to a standard scale or range, ensuring consistency and comparability across different data points. This process may be performed in cases where data points vary widely in scale, units, or distribution, as normalization brings all data into a common format. Normalizing data may be a preprocessing step used to enhance the performance and accuracy of algorithms. When building machine learning models, especially those that rely on distance-based calculations (e.g., k-nearest neighbors, support vector machines), normalization helps prevent features with larger scales from disproportionately influencing the model's outputs. For instance, if an AUS model uses images from an applicant's social media content and texts from online review platform, normalization adjusts features from these diverse data type to comparable scales, allowing the model to weigh them more fairly in predictions.

Normalization techniques may include min-max scaling (scaling values to a fixed range, typically 0 to 1) and z-score standardization (scaling values based on the data's mean and standard deviation). By normalizing data, AUS models may accurately assess applicant profiles.

Some disclosed embodiments involve a non-transitory computer readable medium containing instructions that when executed by at least one processor cause the at least one processor to perform inputting the preprocessed data into the machine learning model. For instance, the system may preprocess the data collected from various electronic sources, such as income details, credit history, demographic information, and social behavior by normalizing numeric values, encoding categorical data, and removing incomplete or redundant entries. This preprocessed data may be then fed into a trained machine learning model, such as a neural network or decision tree-based algorithm, specifically designed to predict application outcomes, such as loan return on investment. The machine learning model uses the input data to generate predictions or classifications.

Machine learning input refers to the data fed into ML models for processing and analysis. Machine learning inputs can come in various formats, depending on the task at hand. They may include structured data (like numerical values or categories in tables), unstructured data (such as text, images, or audio), or time-series data (which captures data points over time). In an AUS, these inputs may encompass credit scores, income levels, transaction histories, demographic information, or even external data sources such as social media, web and real estate records.

Some disclosed embodiments involve machine learning models. Machine learning model refers to a mathematical representation or algorithm trained on historical data to recognize patterns, make predictions, or classify information. The model learns from data by identifying correlations and relationships within the dataset, allowing it to generalize and apply this learned knowledge to new, previously unseen data.

Within AUS, a machine learning model may be utilized for evaluating a degree of uncertainty in a model's prediction for an applicant's financial reliability profiles and making informed decisions. These models may process vast amounts of data to generate insights about an applicant's likelihood of creditworthiness. Types of models commonly used in AUS may include classification models (which categorize applicants into risk levels), regression models (which predict continuous outcomes like the probability of default), random forest models (that predict eligibility by analyzing numerous applicant features) and clustering models (which group applicants with similar profiles).

Some disclosed embodiments involve a label. A label refers to a specific tag or annotation assigned to data points within a dataset, indicating the correct category, outcome, or value associated with each data point. Labels may serve as a component in supervised machine learning, guiding models by providing known outputs that can be learned and predicted on new data. In the context of AUS, labels might represent classifications such as “approved” or “denied” for loan applications or degree of uncertainty categories like “low,” “medium,” or “high” based on applicant profiles. These labels allow models to identify patterns, make accurate predictions, and refine their decision-making processes. Data labeling may be a manual or semi-automated process that may involve domain experts to ensure the data reflects real-world outcomes accurately. Properly labeled data enables AUS models to recognize patterns in applicant profiles and make predictions that align with historical decisions and current risk thresholds. Additionally, labels contribute to the transparency and interpretability of AUS models, as they clarify the criteria for model predictions.

Machine learning models in AUS may be trained on labeled datasets, which often include data on previously assessed applicants and their repayment behavior with user-provided feedback. Once trained, the model may automatically analyze new applications, improving speed and consistency in decision-making. To maintain accuracy, models may require retraining with updated data to adapt to changing conditions of applicants and users. For instance, retraining a machine learning model in AUS with updated data involves feeding the model new, labeled datasets that reflect recent applicant behaviors, market trends, or feedback from previous underwriting decisions. This process ensures the model stays aligned with current patterns and regulatory requirements. During retraining, the model integrates fresh data, such as new social behavior, or changes in economic conditions, while retaining valuable insights from previously learned data. Techniques such as incremental learning may be employed, allowing the model to adapt efficiently without requiring a complete rebuild. By incorporating updated data, retraining helps improve the model's accuracy, reduces bias, and ensures that underwriting decisions remain fair, relevant, and aligned with evolving user needs.

Some disclosed embodiments involve a training data set. A training data set refers to a collection of labeled data used to teach a machine learning model how to recognize patterns, make predictions, or classify data. This data set contains input-output pairs, where each input may be associated with the correct outcome (or label) that the model aims to predict. The model uses these examples to learn the relationships and correlations within the data, adjusting its parameters to improve accuracy and generalize its predictions to new data. In AUS, the training data set typically includes past applicant information and an applicant's performance. The data may be labeled to indicate whether applicants were approved or denied, as well as any other relevant results. By analyzing this historical data, the model learns to identify factors that influence creditworthiness and degree of uncertainty in a model's prediction for an applicant's financial reliability profiles, enabling it to make more informed decisions on new applications. A well-curated and diverse training data set may be utilized for building a reliable model, as it ensures the model can generalize to various applicants and financial scenarios. Training data sets may need regular updating to reflect changes in conditions of the applicants and users' feedback.

Some disclosed embodiments involve underwriting decisions. Underwriting decisions refer to the determinations made by financial institution tools, AUS, on whether to approve, deny, or modify the terms of a financial product for an applicant. These decisions are grounded in evaluating an applicant's creditworthiness and degree of uncertainty in a model's prediction for an applicant's financial reliability profiles. Historical underwriting decisions refers to an application previously evaluated by the AUS system. Underwriting decisions generated by machine learning may be more efficient and consistent compared to traditional methods if fairness is ensured and bias mitigated according to disclosed embodiments.

Some disclosed embodiments involve financial gain. Financial gain refers to the profit or positive return achieved from an investment, business activity, or financial transaction after deducting any associated costs or expenses. This term broadly encompasses revenue growth, capital appreciation, and other forms of monetary benefit that enhance an individual's or organization's financial position. For lenders, financial gain might come from approving low-risk loans with competitive interest rates, while effectively minimizing losses from high-risk applicants. For investors, financial gain may arise from diversified investment opportunities within automated platforms that use machine learning to improve portfolio returns. By accurately evaluating an applicant's financial reliability profiles and tailoring investment choices, machine learning-enabled systems can provide users with better financial outcomes.

Some disclosed embodiments involve user-provided feedback. User-provided feedback refers to the input, evaluations, or comments shared by users regarding their experience, satisfaction, or specific interactions with a product, service, or system. This feedback may include ratings, reviews, suggestions, or complaints, which provide valuable insights into how well a system meets user needs and expectations. Machine learning models within the AUS may be retrained or adjusted based on this feedback to better align with user needs, reduce errors and bias, and improve overall system reliability. Additionally, user-provided feedback helps AUS developers identify necessary updates, fine-tune labels, and ensure that models are equitable, transparent, and responsive to changing applicants' conditions and users' expectations.

Some disclosed embodiments involve approved applications. Approved applications or previously approved applications refer to the set of requests or submissions that have met the necessary criteria for acceptance and have been granted approval by a decision-making entity, such as AUS. Approval indicates that the applicant has been deemed eligible for the requested financial product, such as a loan, insurance policy, or credit line, and may proceed under agreed-upon terms. Within the AUS, approved applications are those that have passed the AUS's algorithmic evaluation based on various factors. The AUS analyzes the criteria through machine learning models to determine the applicant's financial reliability profiles. Applications that meet or exceed the predefined thresholds are approved automatically. Approved applications are recorded in the system and may serve as training data for further model refinement, helping the AUS adapt to changing applicant profiles and economic conditions.

Some disclosed embodiments involve a feature selection module. A feature selection module may be a component within a machine learning pipeline that identifies the relevant and impactful features (variables or attributes) in a dataset to improve model accuracy, efficiency, and interpretability. This module generates, assesses and selects the features that contribute most to the predictive power of a model, filtering out irrelevant or redundant data that could detract from model performance. Feature generation involves creating new features from existing application data to enhance the predictive power and accuracy of machine learning models. Conventionally, this process often requires significant manual effort and domain expertise to identify meaningful patterns and relationships. However, with the deep learning, feature generation has become more automated and dynamic. Deep learning models can automatically learn and extract features directly from raw data, uncovering complex patterns that may not be immediately apparent to human experts. For instance, in AUS deep learning models may analyze unstructured data such as transaction histories, text-based applicant reviews, or images of the applicants' products. These models generate features that represent nuanced behavioral trends, sentiment scores, or visual indicators of reliability and creditworthiness.

Within AUS, a feature selection module may play a role in refining the model's decision-making process by focusing on key features that accurately reflect an applicant's financial reliability profiles. By way of example, in a loan AUS model, relevant features might include unreliable behavior, success trajectory, credit score, debt-to-income ratio, and employment history, while less relevant features might be filtered out. The module may apply statistical techniques, such as correlation analysis, mutual information, and machine learning algorithms like Recursive Feature Elimination (RFE) or Lasso regression, to rank and select the optimal set of features. The module may utilize users' provided feedback to rank and select the optimal set of features. This selective approach may reduce the complexity of the model, improve processing speed, and enhance the interpretability of underwriting decisions. By focusing only on essential features, the feature selection module not only enhances model accuracy but also helps ensure that underwriting decisions are based on relevant, unbiased data, reducing potential for overfitting and enhancing the model's adaptability to new data.

Some disclosed embodiments involve a non-transitory computer readable medium containing instructions that when executed by at least one processor cause the at least one processor to perform receiving a plurality of candidate features wherein features are associated with the applicant's behavior. For instance, features like debt-to-income ratio, transaction frequency, or sentiment from the applicant's product reviews are created. The features are evaluated to find the highest correlation with loan repayment likelihood and users' satisfaction. Then numerical features like income are rescaled. The features are iteratively updated with new approved applications selected by the users.

Some disclosed embodiments may involve a non-transitory computer readable medium containing instructions that when executed by at least one processor cause the at least one processor to perform receiving a plurality of candidate features wherein features are associated with the applicant's behavior. Candidate features refer to specific measurable attributes derived from an applicant's actions, patterns, or tendencies, which provide insights into their financial reliability and risk level. By receiving and processing these features, the processor may evaluate indicators for behavioral pattern, such as reliability in spending consistency, payment punctuality, self-awareness, willingness to experiment, or persistence. These features allow machine learning models to identify patterns and anomalies in behavior that may signal creditworthiness.

Some disclosed embodiments involve dynamical identification. Dynamical identification refers to the continuous, adaptive process of recognizing patterns, characteristics, or attributes within a system as they evolve over time. In machine learning and data systems, dynamical identification enables a model or algorithm to adjust to new information dynamically, refining the model's understanding and improving decision-making accuracy based on incoming data. Within AUS, dynamical identification may involve real-time updates to financial reliability profiles, social behavior, or financial behaviors as fresh data becomes available. This allows the AUS to adaptively reassess an applicant's eligibility as economic conditions change. For instance, as an applicant's credit score, income level, or spending behavior shifts over time, the system can dynamically identify these changes and modify underwriting decisions accordingly. Dynamical identification may be achieved through algorithms capable of real-time processing, such as online learning models or recurrent neural networks, which can incorporate new data without needing to fully retrain the model from scratch. The AUS remains accurate and responsive, ensuring that risk assessments are current and that decisions reflect the most recent data available. This adaptive capability may be valuable in volatile or rapidly changing financial environments, where static models may quickly become outdated.

Some disclosed embodiments involve the applicant's behavior. Applicant behavior refers to the patterns, actions, and tendencies displayed by applicants, which can include financial habits, spending patterns, payment histories, and interactions with financial products. Within AUS, analyzing applicant behavior impacts an understanding of creditworthiness and reliability. Machine learning models within the AUS may use applicant behavior to identify trends that indicate potential uncertainty or fluctuating financial condition. These behavioral insights enable unbiased and accurate underwriting assessments, as they provide additional context beyond static financial metrics like income and credit score. Additionally, applicant behavior data may be used in customizing financial products, adjusting interest rates, or recommending financial products that align with users' interest and needs, ultimately supporting more personalized and reliable underwriting decisions. Applicant behavior may entail behaviors that indicate unreliability. For instance, an applicant may demonstrate a pattern of impulsive purchases on their social media. As another example, a business owner may exhibit aggressive behavior towards their employees.

Some disclosed embodiments may involve a non-transitory computer readable medium containing instructions that when executed by at least one processor cause the at least one processor to perform analyzing the candidate features to determine their weight, wherein the feature weight indicates the predictive value of each feature with respect to a target outcome.

Some disclosed embodiments involve feature weight. Feature weight refers to the numerical value assigned to a feature in a machine learning model to indicate its relative importance or contribution to the model's predictions. Within AUS, feature weights help determine how much influence a particular feature—such as income, credit score, or applicants' behavior—has on the model's decision-making process. These weights may be derived during the training phase of the model, as it learns from data and identifies which features are most predictive of the desired outcome. The feature weights may be analyzed and identified upon receiving users' provided feedback after training the model. Feature weights enable the AUS to focus on the impactful attributes while minimizing the influence of less relevant or noisy features. For instance, a higher feature weight assigned to “income to debt” might indicate its strong predictive power for assessing an applicant's risk of default. Understanding feature weights may improve the transparency and interpretability of machine learning models, helping stakeholders understand why certain decisions are made. For instance, a high feature weight for the applicant's behavior in a loan approval model may reflect its importance in predicting creditworthiness. A moderate feature weight for the brand perception may indicate its relevance in the applicant's creditworthiness. A low feature weight for age may suggest minimal impact on the model's predictions compared to other features.

Some disclosed embodiments involve predictive value. Predictive value refers to the effectiveness or relevance of a particular feature, model, or dataset in accurately forecasting a specific outcome or decision. In the field of AUS, predictive value measures how well a given feature or model contributes to reliable and accurate predictions, such as loan approvals, degree of uncertainty assessments, or creditworthiness evaluations. High predictive value indicates that a feature or model provides significant insight into the likelihood of an event, while low predictive value suggests minimal contribution to the decision-making process. In AUS, predictive value may be used to identify and prioritize features that are most influential in determining underwriting outcomes. For instance, a feature like “payment history” may have a relatively low predictive value for assessing loan repayment likelihood. Contrary to conventional systems, “social behavior” may have a high predictive value for small businesses. Machine learning models may evaluate predictive value during the training process or dynamic modification by analyzing correlations, importance scores, or statistical metrics like precision and recall. For instance, predictive value may include a credit score having a high predictive value in determining loan default risk. Employment history may have a moderate predictive value for assessing income stability. Spending patterns may have a high predictive value for evaluating financial behavior and budgeting habits. Zip code may have a low predictive value for assessing individual creditworthiness but may have a high predictive value for performing broader demographic analyses. Understanding and optimizing predictive value may be needed to ensure that machine learning models in AUS are accurate, fair, and efficient, enabling better underwriting decisions tailored to applicant profiles.

Some disclosed embodiments may involve a non-transitory computer readable medium containing instructions that when executed by at least one processor cause the at least one processor to perform selecting, based on the feature weight, a subset of features that maximizes model performance.

Some disclosed embodiments involve a model performance metric. A model performance metric may be a quantitative measure used to evaluate the effectiveness, accuracy, and reliability of a machine learning model. These metrics help assess how well a model performs on specific tasks, such as classification, regression, or prediction, by comparing the model's outputs to known outcomes. In machine learning, performance metrics guide model selection, optimization, and validation, ensuring that the chosen model meets the desired criteria for its application. In the context of AUS, model performance metrics are crucial for determining the accuracy and fairness of models used in credit risk assessment, loan approval prediction, and financial decision-making. These metrics provide insights into how well the model distinguishes between different risk categories, identifies potential defaulters, or predicts applicant eligibility. Common metrics may include accuracy, precision, recall, and F1-score. By continuously monitoring these metrics, AUS platforms maintain model reliability and adapt to changes in applicant data or market conditions. For instance, model performance metrics may include accuracy that measures the percentage of correctly classified loan applications (e.g., “approved” or “denied”). Precision evaluates the proportion of true positive predictions (e.g., correctly approved applicants) out of all positive predictions. Recall (sensitivity) indicates the model's ability to identify all true positive cases, such as correctly detecting all eligible applicants. F1-score combines precision and recall into a single metric to balance false positives and false negatives in underwriting decisions. AUC-ROC measures the model's ability to distinguish between high-risk and low-risk applicants across various classification thresholds.

Some disclosed embodiments may involve a non-transitory computer readable medium containing instructions that when executed by at least one processor cause the at least one processor to perform automatically generating a set of hyperparameters. This step may involve leveraging algorithms such as grid search, random search, or advanced methods like Bayesian optimization to explore various hyperparameter combinations efficiently. For example, the system may determine the optimal learning rate, batch size, and regularization strength for a machine learning model used to assess loan applications. By systematically testing these hyperparameter combinations on a validation dataset, the processor may identify configurations that maximize the model's predictive performance while minimizing overfitting.

For instance, the system may start by generating a range of values for the learning rate (e.g., 0.001 to 0.1), the number of layers in a neural network (e.g., 2 to 10), and the dropout rate (e.g., 0.1 to 0.5). The processor iteratively tests these combinations on historical application data, adjusting the hyperparameters based on performance metrics such as accuracy or F1-score.

A hyperparameter is a configurable variable that is set before the training process of a machine learning model begins and controls the model's behavior and learning process. Unlike parameters, which are learned by the model during training (e.g., weights and biases), hyperparameters are external settings that influence the structure and performance of the model, such as the learning rate, number of epochs, regularization strength, or the depth of a decision tree. In the context of machine learning and AUS, hyperparameters are used to optimize models used for creditworthiness assessment or loan approval decisions. Properly tuned hyperparameters ensure that the model achieves a balance between overfitting (where the model may be too closely aligned with training data) and underfitting (where the model fails to capture underlying patterns). Common techniques for hyperparameter tuning in AUS include grid search, random search, or automated methods like Bayesian optimization, which help identify the best combination of hyperparameters for accurate and efficient underwriting decisions. Some potential hyperparameters include learning rate, max depth, regularization strength, and number of neurons in a layer. Learning rate refers to how quickly a gradient descent algorithm updates the model's parameters during training, influencing the speed and stability of convergence. Max depth refers to the maximum depth of a decision tree in a random forest model used to classify applicants into risk categories. Regularization strength refers to the penalty applied to large weights in models like logistic regression to reduce overfitting and improve generalization. The number of neurons in a layer refers to the complexity of a neural network model used to analyze applicant behavior and transaction patterns.

Some disclosed embodiments involve automatically generating a set of hyperparameters. Automatically generating a set of hyperparameters refers to the process in which a machine learning system selects optimal hyperparameter values for a model without manual intervention. By automating hyperparameter selection, the system can explore a wide range of hyperparameter combinations to identify the configuration that yields the best results for the task at hand. In the context of machine learning and AUS, automatically generating a set of hyperparameters ensures that the models used for risk assessment and decision-making are fine-tuned for maximum accuracy and efficiency. Techniques such as grid search, random search, or advanced methods like Bayesian optimization and automated machine learning (AutoML) are commonly employed to achieve automated hyperparameter selection. Automating hyperparameter tuning reduces the time and expertise needed to configure models, allowing AUS platforms to rapidly adapt to changing data distributions, applicant profiles, or regulatory requirements. For instance, automatically generating a set of hyperparameters may include Selecting the learning rate and batch size for a gradient boosting model used to predict loan default risk. As another example, automatically generating a set of hyperparameters may include determining the optimal number of decision trees and their maximum depth in a random forest model for credit scoring. By automating hyperparameter generation, AUS platforms may improve model performance while streamlining the process of implementing advanced machine learning techniques in underwriting.

Some disclosed embodiments may involve a non-transitory computer readable medium containing instructions that when executed by at least one processor cause the at least one processor to perform defining a search space of candidate hyperparameters and associated ranges based on model requirements and training data. Defining the search space may involve specifying the boundaries within which the hyperparameters will be optimized, ensuring that the search focuses on relevant values that align with the model's architecture, the nature of the training data, and the intended application. Defining a well-structured search space helps balance computational efficiency with the need for accurate and robust model performance.

In some embodiments, the processor may define a search space for candidate hyperparameters such as the learning rate (e.g., values ranging from 0.001 to 0.1), the number of decision tree estimators in a random forest (e.g., 50 to 500), and the maximum depth of each tree (e.g., 5 to 20). These ranges are tailored to the model's complexity and the size of the training dataset, such as a dataset containing the applicant's information and application data histories. The processor may use this predefined search space to iteratively test and evaluate different combinations of hyperparameters, refining the model's performance while avoiding unnecessary computational overhead. By defining appropriate ranges for hyperparameters, the system ensures that the optimization process yields a model configuration that is well-suited to the specific requirements of underwriting tasks, such as identifying high-risk applicants or predicting the likelihood of loan repayment.

Some disclosed embodiments involve search space. The search space for hyperparameters refers to the range of possible values or configurations that can be explored when tuning the hyperparameters of a machine learning model. Hyperparameters are predefined settings, such as learning rate, batch size, or the number of layers in a neural network, that may affect the model's training process and performance. The search space defines the boundaries within which optimization techniques can test and evaluate various combinations of hyperparameter values to identify the optimal setup for the model. In the context of machine learning and AUS, the search space for hyperparameters impacts fine-tuning models used for the assessment of degree of uncertainty, loan approval predictions, and fraud detection. Efficient search space may improve AUS platforms that balance the computational cost of training with the need to find the best-performing model configuration. Techniques such as grid search, random search, or Bayesian optimization explore the search space systematically or randomly to identify the hyperparameter combinations that yield the highest accuracy, reliability, and efficiency in underwriting decisions.

Some disclosed embodiments involve range. The search space for hyperparameter range refers to the set of possible values or intervals defined for each hyperparameter during the tuning process in a machine learning model. This range specifies the boundaries within which optimization algorithms, such as grid search, random search, or Bayesian optimization, may explore to find the optimal hyperparameter configuration for a given model. The choice of ranges in the search space may impact the quality of the model's performance because ranges impact which hyperparameter combinations are evaluated. For instance, learning rate range may be values between 0.0001 and 0.1 to fine-tune the gradient descent process for credit scoring models. as another example, max depth range may be values from 3 to 15 for the depth of decision trees in a gradient boosting model used for applicant classification.

Some disclosed embodiments may involve a non-transitory computer readable medium containing instructions that when executed by at least one processor cause the at least one processor to perform iteratively adjusting the hyperparameters using a tuning strategy. The iterative adjustment may involve systematically refining hyperparameters based on the performance of the model during each iteration, using predefined optimization methods such as grid search, random search, Bayesian optimization, or gradient-based tuning. The iterative adjustment ensures that the model converges toward an optimal configuration that maximizes predictive accuracy while avoiding overfitting or underfitting. For instance, the processor might start with an initial set of hyperparameters, such as a learning rate of 0.01, a batch size of 32, and a dropout rate of 0.2. Using a tuning strategy like Bayesian optimization, the processor may evaluate the model's performance on a validation dataset after each training cycle, measuring metrics such as precision, recall, or F1-score. Based on these evaluations, the processor may adjust the hyperparameters iteratively—reducing the learning rate to 0.005, increasing the batch size to 64, or modifying the dropout rate to 0.3—aiming to improve the model's ability to accurately predict applicant creditworthiness. Through this iterative process, the system may fine-tune the hyperparameters to strike a balance between performance and computational efficiency, resulting in a model configuration that enhances the AUS's decision-making capabilities for underwriting tasks.

In some embodiments, hyperparameter tuning in an AUS is performed iteratively by testing different combinations of hyperparameters, evaluating model performance metrics such as accuracy or recall, and adjusting the parameters based on these evaluations. Similarly, iterative learning processes may involve retraining models with updated applicant data or incorporating new features into the model. This repetition may allow AUS platforms to adapt to changing data patterns, reduce errors, and continuously improve decision-making for risk assessments or loan approvals.

Some embodiments involve a prediction model. A prediction model refers to a machine learning algorithm or system designed to forecast outcomes based on input data. These models analyze patterns and relationships within historical data to generate predictions for new, previously unseen data. Prediction models may aid decision-making processes in various fields, providing actionable insights by estimating probabilities, classifying categories, or predicting numerical values. In the context of machine learning and AUS, a prediction model may be used to assess applicant eligibility, or likelihood of default. These models may process input features, such as credit score, or applicants' social behavior, to produce outcomes like loan approval decisions or creditworthiness. For instance, logistic regression models may predict the likelihood of loan approval or default based on applicant features. As another example, random forest models may classify applicants into degree of uncertainty categories such as “low,” “medium,” or “high.” As yet another example, gradient boosting models may estimate the probability of successful loan repayment for applicants with varied financial histories. As yet another example, neural network models may analyze complex relationships among features like transaction patterns, credit utilization, and savings behavior to predict risk scores.

Some embodiments may involve a non-transitory computer readable medium containing instructions that when executed by at least one processor cause the at least one processor to perform computing a score for each of the plurality of applications based on the expected performance score and based on a comparison of the expected performance score of one or more predefined thresholds to generate an underwriting decision.

Some disclosed embodiments involve a performance metric. A performance metric is a quantitative measure used to evaluate the effectiveness, reliability, or suitability of an entity, process, or system based on specific criteria. In machine learning, a performance score assesses a model's accuracy, predictive power, or classification ability.

Some disclosed embodiments involve a predetermined threshold. A predetermined threshold may refer to a set value or limit established before processing data that serves as a benchmark for making decisions or classifications within a system. In machine learning and automated systems, a predetermined threshold may be used to determine if an output meets certain criteria or to separate different classes based on predictive scores. Within AUS, a predetermined threshold may be applied to applicants' financial reliability profiles or performance metrics to decide whether to approve, deny, or adjust terms for an application. For instance, a credit score threshold may be set to define eligibility for loan approval-only applicants whose scores meet or exceed this threshold are approved. These thresholds may be determined based on business rules, regulatory requirements, or historical data analysis, balancing risk management with customer inclusivity. Setting a predetermined threshold allows the AUS to make consistent, data-driven decisions. Thresholds may help define acceptable uncertainty levels, segment applicants, or trigger additional review steps if applications fall within certain ranges.

Some disclosed embodiments involve a hyperparameter tuning module. A hyperparameter tuning module refers to a component within a machine learning pipeline designed to optimize the selection of hyperparameters that control a model's behavior and performance. This module may systematically search for the best set of hyperparameters to improve model accuracy, efficiency, and generalization to new data. Hyperparameter tuning modules may automate this process, using techniques like grid search, random search, or advanced methods such as Bayesian optimization to identify optimal values. Within AUS, a hyperparameter tuning module may be needed for refining machine learning models used in evaluating applicant degree of uncertainty profiles and creditworthiness. By selecting the best hyperparameters, the module enhances the model's ability to predict outcomes more accurately and efficiently. By way of example, tuning hyperparameters like the learning rate or maximum tree depth in a gradient boosting model may help the AUS balance accuracy with processing speed, which may be needed for handling high volumes of applications with minimal delay. The hyperparameter tuning module may iteratively evaluate different combinations of hyperparameters, potentially based on a validation dataset, to find the configuration that maximizes predictive performance. The validation dataset refers to a subset of the dataset that may be used during the training process to evaluate the performance of a machine learning model or hyperparameter configuration. The validation dataset may be distinct from the training dataset (used to fit the model) and the test dataset (used to assess the final performance after training). The validation dataset may help with measuring the model's predictive performance (e.g., accuracy, F1-score) for each hyperparameter configuration. Additionally, the validation dataset may help identify the hyperparameter settings that yield the best balance between underfitting and overfitting. The dataset may ensure that the chosen hyperparameters lead to a model that performs well on data outside of the training set.

In AUS, the validation dataset may include a loan application with known outcomes, such as whether applicants repaid their loans or defaulted and whether the users rated the application with a high satisfaction score. The hyperparameter tuning module may test various configurations (e.g., learning rate, regularization strength) and selects the settings that maximize the models' performance metrics, such as accuracy, or minimize prediction errors on this validation dataset. The hyperparameter tuning process may save time and reduce the manual effort required for model optimization, ensuring that the AUS maintains high accuracy and reliability in underwriting decisions.

Some disclosed embodiments may involve a non-transitory computer readable medium containing instructions that when executed by at least one processor cause the at least one processor to perform providing the plurality of applications for display, wherein the underwriting decision may be approved, with the associated application data on a device associated with the user. This step may involve the underwriting outcomes, such as loan approval status, degree of uncertainty category, or interest rate, which may be presented in an accessible and organized format, allowing users to review and act upon the results efficiently. The application data may be displayed alongside the underwriting decision. This method of display may enhance transparency and provide the necessary context for the user to understand the rationale behind the decision. For instance, in AUS for small business loans, the processor might provide a list of applications on the investor tablet, highlighting those that have been approved. Each entry may include associated data such as the applicant's business name, requested loan amount, repayment terms, and degree of uncertainty assessment category. Additionally, the display may include interactive elements, such as the ability to filter applications by approval status or sort them based on degree of uncertainty scores, improving the usability and efficiency of the underwriting process.

Some disclosed embodiments may involve a non-transitory computer readable medium containing instructions that when executed by at least one processor cause the at least one processor to perform receiving a selection of the plurality of applications from the user.

Some disclosed embodiments involve generating an underwriting decision. The underwriting decision may be based on input features such as income, credit score, applicant social behavior, and other relevant metrics, which the model may evaluate to predict creditworthiness. For instance, in an AUS for personal loans, the processor may analyze an applicant's information. Based on the applicant information and collected data, the model may predict a low degree of uncertainty of default and generate an underwriting decision to approve the loan with favorable terms, such as a low interest rate and a longer repayment period. Simultaneously, for an applicant with a credit score of 710, medium debt-to-income ratio, and negative feedback from the client, the system may generate a decision to either reject the loan or offer a conditional approval with a higher interest rate and stricter repayment terms.

Some disclosed embodiments involve a comparison. In machine learning, a comparison may involve assessing models, features, or outputs to determine which configuration or prediction may be effective. Comparison may serve as a method for decision-making, enabling systems to refine models, select optimal features, or validate predictions. In the context of machine learning and AUS, comparison may play a role in model development, performance evaluation, and decision-making. For instance, an AUS may compare the outputs of different models, such as logistic regression versus random forest, to determine which provides the most accurate creditworthiness predictions. Comparisons may be used to evaluate applicant data against predefined benchmarks, such as industry averages or regulatory standards, to ensure fairness and compliance. Furthermore, AUS platforms may compare applicant profiles to identify relative uncertainty levels and prioritize loan approvals or adjustments. For instance, comparing model performance metrics (e.g., accuracy, precision, recall) to choose the most effective model for predicting loan defaults.

Some disclosed embodiments may involve a non-transitory computer readable medium containing instructions that when executed by at least one processor cause the at least one processor to perform receiving a selection of the plurality of applications from the user. This step may enable the user to interact with the system by choosing specific applications from a list for further review, action, or processing. The selection may allow the system to focus on the selected subset, streamlining the workflow and reducing unnecessary processing of non-relevant data. For instance, in an AUS for small business loans, a loan officer might access a dashboard displaying a list of applications. Each application may be summarized with key information, such as the business name, requested loan amount, and degree of uncertainty. The user may select three applications. Upon receiving the selection, the processor may retrieve detailed information about the chosen applications. This selection may allow the user to focus on evaluating the highlighted cases and provide feedback.

Some disclosed embodiments involve a display. Within AUS, the display typically shows key metrics, underwriting decisions, and other relevant applicants and applications information. By way of example, AUS may display an applicant's profile along with a decision summary, making it easier for financial analysts or investors to review and understand the basis of each underwriting decision. Additionally, visual displays such as charts, dashboards, and tables provide insights into the system's performance, helping stakeholders track trends, detect anomalies, and assess model accuracy over time. An effective display may be designed to be intuitive, allowing users to quickly grasp complex information and navigate through different data layers or filters as needed. Displays may also incorporate visual cues like color-coding or alerts to emphasize high-risk cases or unusual patterns, facilitating faster and more informed decision-making.

Some disclosed embodiments involve a device associated with the user. The device may include smartphones, tablets, laptops, desktops, or wearable technology. The data and activity from these devices may provide additional insights into the user's behavior, location, or engagement patterns, which may enhance the personalization and security of automated systems. Within AUS, devices associated with the user may be used to gather supplementary data for decision-making or to enable multi-factor authentication during the application process. For instance, device information (such as device type, IP address, and geolocation) may help verify the user's identity and prevent fraud. Some systems may also use behavioral data from these devices to assess financial habits or adding an additional layer of context to the machine learning process to suggest the applications to the users.

Some disclosed embodiments involve an investment card and an investment account. An investment card refers to a digital or physical card associated with an account or platform that provides access to investment options or financial products. The investment card may function as a convenient tool for users to manage their investments, view account information, and make purchases or transactions related to their investment portfolio. Investment cards may also allow users to directly engage with crowdsourced investment opportunities, such as small business loans, peer-to-peer lending, or short-term and long-term funds. An investment account refers to a type of financial account specifically designed to hold assets or funds. Investment accounts may allow individuals to buy, hold, and manage a variety of securities, such as stocks, bonds, mutual funds, ETFs, and other investment vehicles. An investment account may be dynamically managed and optimized through data-driven insights. Machine learning algorithms may analyze user profiles and feedback, market trends, and historical data to provide personalized recommendations within the account.

Some disclosed embodiments involve feature analysis permutation importance. Feature analysis permutation importance may refer to a technique used to evaluate the relative importance of features in a machine learning model by measuring the impact of shuffling (or permuting) the values of each feature on the model's predictive performance. This method may disrupt the relationship between a specific feature and the target variable while keeping other features unchanged, allowing the model's accuracy or other performance metrics to reflect how much that feature contributes to predictions. The greater the decrease in performance caused by permuting a feature, the more important that feature may be deemed to be. In the context of machine learning and AUS, feature analysis permutation importance helps identify which applicant attributes—such as income, credit score, applicant social behavior, or payment history—may be influential in underwriting decisions. By understanding feature importance, AUS developers may ensure that models focus on relevant, meaningful data while reducing bias and improving interpretability. This method may be valuable for debugging and validating models, as it highlights whether the model relies on features that align with underwriting objectives and regulatory requirements. As one example, the influence of applicant gambling habits on degree of uncertainty classification may be measured by evaluating how shuffling this feature affects the model's recall. For instance, the impact of credit score on predicting loan approval likelihood by observing changes in accuracy when credit score values may be permuted may be assessed.

Some disclosed embodiments involve SHAP (SHapley Additive exPlanations). SHAP refers to a machine learning interpretability technique based on cooperative game theory, designed to explain the contribution of each feature to a model's predictions. SHAP assigns a Shapley value to each feature, quantifying how much it contributes to increasing or decreasing the predicted outcome for an individual data point. By providing a consistent and theoretically sound method for feature attribution, SHAP may help interpret complex models such as ensemble methods and neural networks, offering insights into why a particular prediction was made. In the context of machine learning and AUS, SHAP may be used to enhance transparency and explainability in underwriting decisions. For instance, when a model predicts that a loan should be approved or denied, SHAP values can illustrate the impact of features such as income, credit score, and applicant social behavior on the decision. This not only helps stakeholders understand the reasoning behind the model's outputs but also ensures compliance with regulatory requirements by providing clear, interpretable justifications for decisions. SHAP may aid in identifying biases, debugging models, and improving trust in automated systems. For instance, in the context of machine learning and AUS, SHAP may explain loan approval predictions by showing that a high credit score may have contributed positively, while a gambling habit may have had a negative impact on the decision. As another example, in the context of machine learning and AUS, SHAP may analyze risk scores by highlighting the top features, such as social behavior and transaction patterns, which may have influenced an applicant's degree of uncertainty classification as “high.” As yet another example, in the context of machine learning and AUS, SHAP may improve model transparency by providing applicant-specific explanations that illustrate why certain features may have mattered more in one case compared to others. As yet another example, in the context of machine learning and AUS, SHAP may detect bias in models by using values to identify cases where irrelevant or unfair features, such as location or age, may have disproportionately influenced predictions.

Some disclosed embodiments involve LIME (Local Interpretable Model-agnostic Explanations). LIME refers to a machine learning interpretability technique that explains the predictions of complex models by approximating them with simpler, interpretable models in a local region around the specific data point being analyzed. LIME may work by perturbing the input data and observing how the model's predictions change, then using this information to create a linear model that highlights the most influential features for the prediction. This approach may make it possible to understand and interpret the decisions of black-box models without needing to alter the underlying model. In the context of machine learning and AUS, LIME may be used to provide applicant-specific explanations for underwriting decisions. For instance, when an AUS model predicts that an applicant is at high uncertainty or denies a loan application, LIME may identify and present the key features, such as credit score, income level, or applicants' behavior, that drove the decision. LIME's model-agnostic nature may make it applicable to a wide range of machine learning models used in AUS, from decision trees to deep neural networks. For instance, LIME in the system disclosed herein may explain application denial decisions by showing that a high debt-to-income ratio and inconsistent payment history had the most significant negative influence. As another example, LIME in the system disclosed herein may highlight positive factors in a degree of uncertainty classification, such as social behavior and a positive branding reputation, which may have contributed to a low degree of uncertainty prediction. As yet another example, the system disclosed herein may test model fairness by using LIME to verify that protected attributes like race or gender may not be disproportionately influencing predictions. As yet another example, the system disclosed herein may include debugging models by identifying unexpected patterns in predictions where irrelevant features, such as ZIP codes, significantly affect outcomes.

Some disclosed embodiments involve a web scraping module. A web scraping module refers to a software component designed to automatically extract data from websites by parsing the websites' HTML structure or interacting with web elements. This module may collect unstructured or semi-structured data from online sources and convert it into a structured format that can be analyzed or integrated into machine learning systems. Web scraping modules often include tools for accessing web pages, navigating through links, and extracting specific content such as text, images, or metadata. In the context of machine learning and AUS, a web scraping module may gather relevant data from online resources to enhance underwriting decisions. For instance, the web scraping module may scrape data from credit bureau websites, public business profiles, or social media platforms to retrieve information about an applicant's financial status, business performance, or market reputation. By incorporating this external data into the AUS, the web scraping module enables comprehensive assessments and provides additional insights that complement traditional data sources. For instance, web scraping modules in the system disclosed here may include extracting financial data from government websites or public databases to validate applicant income or employment claims. Another example may involve scraping reviews and ratings from online platforms to assess the reputation of a business seeking a financial product. Yet another example may involve gathering industry-specific data from market analysis websites to benchmark an applicant's business performance against competitors.

Some disclosed embodiments involve Application Programming Interfaces (APIs). APIs may define the methods and data formats that applications can use to request and send information, facilitating seamless integration and interaction between systems. APIs may be utilized for building flexible and scalable systems, allowing developers to access specific functionalities or data from other software platforms without exposing their internal complexities. In the context of machine learning and AUS, APIs may serve as a bridge to integrate external data sources, tools, and services into the underwriting process. APIs may allow the AUS to retrieve real-time information from social media, government registries, or market data platforms, ensuring that decisions may be based on the most current and accurate data. Additionally, APIs may enable communication between different components within the AUS, such as machine learning models, user interfaces, and data storage systems, to ensure smooth and efficient operation. For instance, banking APIs may allow access to applicant account information, such as transaction records and income verification. Another example is government registry APIs for verifying business licenses or tax compliance status. As another example, an API for social media such as X may allow developers to access and interact with the platform to retrieve posts, user profile data, trends, and other social media content. Within the AUS disclosed herein, a social media API like X's may be used to gather public information about an applicant or a business. For instance, the system may retrieve business reviews and tweets to assess the reputation of a business applying for a financial product. In some embodiments, data obtained through APIs may help to analyze sentiment around a business or individual to identify public perception and potential risks. In some embodiments, data obtained through APIs may help monitor trends in an applicant's industry to benchmark performance or identify external factors influencing their financial stability.

Some disclosed embodiments involve standardizing image dimensions and pixel values. Standardizing image dimensions and pixel values may refer to the process of transforming image data into a consistent format to ensure compatibility and optimal performance in machine learning models. Standardization may involve resizing images to uniform dimensions and normalizing pixel values to a specific range, typically between 0 and 1 or −1 and 1. This preprocessing step may ensure that image data is structured in a way that models can process and analyze. In the field of machine learning and AUS, standardizing image dimensions and pixel values may be needed when working with images submitted during loan or insurance applications, such as identity verification documents, property images, or financial statements. Standardizing the data may assist models with interpreting the visual information consistently and with the accuracy of tasks like object recognition, feature extraction, or fraud detection. The standardization may involve resizing, normalization, cropping, padding, and data augmentation. Resizing may involve adjusting images to a consistent resolution (e.g., 224×224 pixels) using interpolation techniques such as nearest-neighbor, bilinear, or bicubic methods. Resizing may ensure that all input images have the same spatial dimensions for compatibility with convolutional neural networks (CNNs). Normalization may involve scaling pixel values to a range between 0 and 1 by dividing by the maximum possible pixel value (e.g., 255 for 8-bit images). Alternatively, centering pixel values around zero may be performed by subtracting the mean and dividing by the standard deviation of the dataset. Cropping may involve uniformly cropping images to a specific aspect ratio or size to eliminate irrelevant areas or align with model requirements. Padding may involve adding borders of consistent color or texture to smaller images to match the dimensions of larger images without distorting the content. Data Augmentation may involve applying transformations such as rotation, flipping, or scaling while maintaining standardized dimensions and pixel ranges.

Some disclosed embodiments involve segmenting videos into frames. Segmenting videos into frames may refer to the process of breaking down a video into its individual image components, known as frames. Each frame represents a single static image captured at a specific point in time during the video. This segmentation may be a preprocessing step in video analysis, enabling machine learning models to analyze temporal and spatial features within the video data. By working with frames, the models may be able to extract meaningful patterns, track movements, and evaluate changes over time. In the field of machine learning and AUS, segmenting videos into frames may be useful for processing video submissions, such as live identity verification, property inspections, or real-time documentation provided by applicants. For instance, frames from a video may be analyzed to verify an applicant's identity, assess damage to property, or validate the authenticity of documents. Segmenting videos into frames may ensure that the system can handle video data systematically and apply image-based machine learning techniques to extract relevant insights. Segmenting videos may involve extracting frames at fixed intervals (e.g., every nth frame or at a specific frame rate) to reduce redundancy while capturing key moments. This may generate a consistent number of frames for analysis, regardless of video length. Segmenting videos may involve dynamic sampling, which is extracting frames based on specific criteria, such as changes in scene or motion intensity, to focus on areas of interest. Dynamic sampling may be useful for scenarios requiring attention to key events or transitions in the video. Segmenting videos may involve full frame extraction that may be extracting every frame in the video, typically for high-resolution analysis or when all content may be deemed important. Full frame extraction may be used in tasks requiring comprehensive temporal analysis. Segmenting videos may involve frame rate adjustment that may normalize the frame rate (e.g., converting 30 frames per second (fps) to 10 fps) to match the processing capabilities of the system or the requirements of the model. Segmenting videos may involve key frame extraction that may identify and extract only the most informative frames, such as those with significant changes in content. Key frame extraction may reduce computational cost while retaining critical information.

Some disclosed embodiments involve predefined intervals. Predefined intervals may refer to fixed or predetermined time or value ranges used to segment, group, or analyze data in a structured manner. These intervals may serve as boundaries or units for processing and interpreting data, allowing machine learning models to focus on specific segments or subsets. In the context of machine learning, predefined intervals may be used for time-series data, event tracking, or categorizing numerical data into bins for analysis. In the field of machine learning and AUS, predefined intervals may be applied to segment financial data, applicant behavior, or temporal events for risk assessment and decision-making. For instance, payment histories may be analyzed at predefined monthly intervals to evaluate an applicant's repayment consistency. Similarly, predefined business plans may help categorize applicants into degree of uncertainty categories. Using predefined intervals may enable AUS platforms to standardize data processing, ensuring consistent and fair underwriting decisions. For instance, predefined intervals may include time-based intervals, which may involve segmenting data by specific time periods, such as daily, weekly, or monthly intervals. Predefined intervals may be used for analyzing an applicant's behavior, income deposits, or transaction patterns. As another example, predefined intervals may include range-based intervals, which may be defining fixed numerical ranges, such as income bands (e.g., $0-$50,000, $50,001-$100,000) or credit score brackets. Predefined intervals may be useful for categorizing applicants into predefined financial tiers for risk analysis. As another example, predefined intervals may include event-based intervals that may be segmenting data based on the occurrence of specific events, such as late payments or high spending spikes. This segmenting may enable focused analysis on critical behaviors impacting underwriting decisions. As another example, predefined intervals may include dynamic intervals that may be adjusting intervals based on data characteristics, such as percentiles or quantiles, to ensure balanced grouping. Dynamic intervals may be effective when data distribution may be uneven, such as skewed income ranges. As another example, predefined intervals may include sliding windows, which may involve using overlapping intervals, such as moving 30-day windows, to analyze trends over time. Sliding windows may be helpful for identifying patterns in dynamic or evolving applicant behaviors.

Some embodiments may include symbols, emojis, and hyperlinks. These elements may provide contextual, emotional, or functional information but may complicate text processing for machine learning systems. In the field of machine learning and AUS, symbols, emojis, and hyperlinks may be encountered when analyzing unstructured text data, such as social media activity, customer reviews, or applicant-submitted content. Properly handling these elements may be needed to ensure that text data may be preprocessed effectively, allowing machine learning models to focus on meaningful patterns without being misled by irrelevant or noisy data. For instance, hyperlinks may provide insights into an applicant's business operations, while emojis and symbols may offer additional context in sentiment analysis for reputation assessment. As an example, the symbols, emojis, and hyperlinks may be processed by tokenization, which may involve breaking down text into smaller units (tokens) that include symbols, emojis, and hyperlinks as separate entities. Tokenization may help to preserve contextual meaning when these elements may be important for analysis. As another example, the symbols, emojis, and hyperlinks may be processed by removal, which may involve eliminating symbols, emojis, and hyperlinks from the text if they may be deemed irrelevant to the task (e.g., creditworthiness assessment). Removal may simplify the data for models that do not require these elements. As another example, the symbols, emojis, and hyperlinks may be processed by normalization by converting emojis to text descriptions (e.g., [symbol] →“happy”) or standardizing symbols to a unified format (e.g., “#Finance”→“Finance”). Normalization may be useful in sentiment analysis or categorizing content. As another example, the symbol, emojis and hyperlinks may be processed by feature engineering, which may involve treating the presence of specific symbols, emojis, or hyperlinks as features for analysis, such as the frequency of “$” in financial discussions or the sentiment conveyed by emojis. Feature engineering may add additional context to the model's decision-making process. As another example, the symbol, emojis and hyperlinks may be processed by URL expansion, which may involve extracting metadata or content from hyperlinks (e.g., titles, descriptions, or destination URLs) for further analysis. URL expansion may help enrich applicant or business profiles based on linked web content. As another example, the symbol, emojis and hyperlinks may be processed by embedding representation, which may involve encoding emojis and symbols into vector representations to be used in machine learning models, ensuring they contribute to predictive tasks when relevant.

Some disclosed embodiments involve performing stop-word removal. Stop-word removal may refer to the process of eliminating commonly used words that do not contribute significant meaning to text analysis or predictive modeling. Stop words may include terms such as “and,” “the,” “is,” “in,” and “of,” which may appear frequently in text but provide little to no value in distinguishing patterns or contextual relationships. Removing these words may reduce noise in the data and improve computational efficiency without affecting the quality of insights drawn from the remaining text. In the field of machine learning and AUS, stop-word removal may be a preprocessing step for analyzing unstructured text data, such as application descriptions, customer reviews, or social media posts. By removing stop words, AUS platforms may focus on keywords and phrases that may be more indicative of applicant behavior, sentiment, or financial reliability. As such, models may prioritize meaningful content, improving their ability to identify trends and make accurate underwriting decisions. Stop-word removal may include using predefined stop-word lists, which may employ standard libraries (e.g., NLTK, SpaCy) that provide lists of common stop words to filter out irrelevant terms. Using predefined stop-word lists may be useful for general-purpose text preprocessing tasks. The stop-word removal may include using custom stop-word lists that may involve creating domain-specific stop-word lists tailored to AUS applications, excluding potentially irrelevant terms like “loan,” “applicant,” or “credit” if they appear redundantly. Using custom stop-word lists may enhance model relevance in specific contexts. Stop-word removal may include using tokenization, which may involve segmenting text into individual tokens (words or phrases) and filtering out those matching stop-word lists. Tokenization may improve efficient processing and compatibility with downstream tasks. Stop-word removal may include using stemming and lemmatization integration, which may involve performing stop-word removal alongside stemming (reducing words to their root forms) or lemmatization (normalizing words) to refine the text further. Stemming and lemmatization integration may reduce redundant variations of unimportant words. Stop-word removal may include using frequency-based filtering, which may involve identifying and removing words that occur above a predefined frequency threshold, assuming that highly frequent words may be likely to be stop words. Frequency-based filtering may allow dynamic identification of irrelevant terms in domain-specific datasets. Stop-word removal may include using part-of-speech tagging, which may involve identifying parts of speech (e.g., articles, prepositions) and removing those that may be considered as stop words. Part-of-speech tagging may improve the precision of stop-word removal in complex sentences.

Some disclosed embodiments involve stemming. Stemming may refer to a text preprocessing technique in natural language processing (NLP) that reduces words to their root or base form by removing prefixes, suffixes, or other derivational affixes. The resulting stem may not always be a linguistically correct word but serves as a standardized representation of related terms. For instance, words like “running,” “runner,” and “runs” can be reduced to the stem “run.” Stemming may help machine learning models process text data efficiently by minimizing redundancy and focusing on the core meaning of words. In the field of machine learning and AUS, stemming may be applied to textual data such as the applications, applicant reviews, or social media posts. By simplifying words to their stems, stemming may reduce the dimensionality of the text data, making it easier for models to identify patterns, keywords, and relationships relevant to risk assessment, creditworthiness, or sentiment analysis. For instance, stemming may ensure that variations of a word like “payment” (e.g., “payments” or “paying”) may be treated as a single term, improving the consistency and interpretability of features used in underwriting models. As an example, stemming may involve rule-based stemming, which may involve employing predefined rules to strip affixes from words (e.g., removing “-ing,” “-ed,” “-s”). Rule-based stemming may be simple and computationally efficient but may produce inaccurate stems. As another example, stemming may involve porter stemmer, which may involve an algorithm that applies heuristic rules to iteratively reduce words to their stems. As another example, stemming may involve Lancaster stemmer, which may involve an aggressive stemming algorithm that produces short stems by removing characters. Lancaster stemmer may be useful for applications requiring extensive dimensionality reduction. As another example, stemming may involve snowball stemmer, which may be an extension of the porter stemmer, offering improved performance and support for multiple languages. Snowball stemmer may be effective for multilingual AUS applications. As another example, stemming may involve custom stemming, which may involve developing domain-specific stemming rules tailored to AUS, such as focusing on financial terms like “investment” and “investing.” Custom stemming may ensure relevance and accuracy in domain-specific datasets. As another example, stemming may involve integration with tokenization, which may involve combining stemming with tokenization to preprocess text at the word level while ensuring compatibility with downstream analysis tasks. integration with tokenization may be used in NLP pipelines for AUS.

Some disclosed embodiments involve lemmatization to reduce text complexity. Lemmatization may refer to a text preprocessing technique in natural language processing (NLP) that reduces words to their base or dictionary form, known as a lemma, while considering the context and part of speech. Unlike stemming, which often removes affixes without understanding the word's meaning, lemmatization produces linguistically accurate root forms. For instance, “running,” “ran,” and “runs” would all be lemmatized to “run,” but “better” might be lemmatized to “good” based on its grammatical context. In the field of machine learning and AUS, lemmatization may be needed for analyzing textual data such as loan applications, user reviews, or social media contents. By normalizing words to their lemmas, lemmatization may improve consistency in the representation of text data, reducing noise and improving the accuracy of feature extraction. Lemmatization may be useful in AUS for tasks like sentiment analysis, keyword extraction, and topic modeling, enabling models to focus on the meaning of words rather than their variations. Lemmatization may involve dictionary-based lemmatization, which may involve using precompiled dictionaries, such as WordNet, to map words to their lemmas based on their forms and parts of speech. Dictionary-based lemmatization may be effective for general NLP tasks but may require customization for domain-specific use. Lemmatization may involve rule-based lemmatization, which may involve applying language-specific grammatical rules to identify and reduce words to their base forms. Rule-based lemmatization may improve control over accuracy. Lemmatization may involve part-of-speech (POS) tagging integration that may involve combining lemmatization with POS tagging to ensure context-aware reductions (e.g., distinguishing between noun and verb forms of the same word). POS tagging integration may enhance the precision of lemmatization in complex text. Lemmatization may involve lemmatization libraries and tools, which may involve leveraging NLP libraries such as NLTK, SpaCy, or STANFORD CoreNLP that provide built-in lemmatization functions. Lemmatization libraries and tools may be used for efficient preprocessing pipelines in AUS. Lemmatization may involve domain-specific lemmatization that may involve developing lemmatization rules and dictionaries tailored to financial or underwriting contexts, focusing on terms like “investment,” “repayment,” or “defaults.” Domain-specific lemmatization may improve relevance and accuracy for industry-specific text analysis. Lemmatization may involve hybrid approaches that may involve combining dictionary-based and rule-based methods to balance efficiency and contextual accuracy. Hybrid approaches may be useful for multilingual applications or datasets with mixed content.

In the field of machine learning and AUS, language processing may play a role in analyzing unstructured data such as loan application descriptions, customer feedback, and applicant-submitted documents. Language processing techniques may enable AUS to extract relevant information, classify documents, and evaluate sentiment, supporting informed underwriting decisions. For instance, analyzing sentiment in customer reviews may provide additional insights into an applicant's business reputation, while processing financial documents ensures accurate extraction of income or expense details. As another example, language processing may be performed by Named Entity Recognition (NER), which may involve identifying and classifying entities in text, such as names, dates, or monetary values. NER may help extract applicant names, business details, or financial figures from documents. As another example, language processing may be performed by sentiment analysis, which may involve determining the sentiment (e.g., positive, neutral, negative) expressed in text. Sentiment analysis may support evaluating customer reviews or social media content for assessing applicant credibility. As another example, language processing may be performed by parsing and syntax analysis, which may involve analyzing sentence structures to understand grammatical relationships between words. Parsing and syntax analysis may be useful for interpreting complex loan agreement clauses. As another example, language processing may be performed by semantic analysis, which may involve understanding the meaning and context of words or phrases in text. Semantic analysis may enable precise evaluation of applicant-provided information in AUS workflows. As another example, language processing may be performed by language models, which may involve utilizing pre-trained language models, such as BERT or GPT, for advanced text comprehension and prediction. Language models may be useful for generating summaries of long financial or business documents or predicting missing information. As another example, language processing may be performed by text normalization, which may involve standardizing text by removing stop words, correcting spelling errors, or converting text to lowercase. Text normalization may ensure consistency in processing applicant-submitted information.

Some disclosed embodiments involve a desired interest rate. A desired interest rate may refer to the specific rate of interest that an applicant aims to achieve on a financial product. The desired interest rate may reflect the applicant's target or expectation for returns. A desired interest rate may serve as a parameter in underwriting and decision-making processes. For applicants, the desired interest rate may be factored into a model that assesses creditworthiness. AUS may utilize machine learning to determine the likelihood of meeting an applicant's desired interest rate, to ensure a balance between expectations and profitability. Machine learning models within AUS may analyze historical data to predict achievable interest rates. By considering desired interest rates, the AUS may enhance application acceptance rates and optimize users' satisfaction. Within an AUS, aligning the final interest rate with the applicant's desired rate may improve user experience.

Some disclosed embodiments involve a loan amount. The loan amount may be a parameter in the underwriting process. Some disclosed embodiments involve a term for profit. A term for profit may refer to a measure of profitability calculated based on the gain or loss generated by an investment relative to the initial cost of that investment. ROI may be expressed as a percentage and serve as a common metric to assess the efficiency or potential profitability of an investment.

Some disclosed embodiments involve a management fee. A management fee may refer to a fee charged by financial institutions, investment managers, or fund administrators for managing investments or financial accounts on behalf of clients. The management fee may be expressed as a percentage of the assets under management. Management fees may help cover one or more costs associated with the disclosed system. The AUS may calculate management fees based on portfolio value or the complexity of the services provided.

Some disclosed embodiments involve an interest rate. Interest rates may represent the cost of borrowing money or the return on investment for lenders and investors. Interest rates may vary based on factors such as loan type, borrower creditworthiness, market conditions, and the applicant's requested interest rate. Within AUS, interest rates may be an output of the underwriting process. Machine learning algorithms within AUS may analyze applicant data to determine an interest rate that reflects the applicant's degree of uncertainty profile. The AUS may use predictive models to dynamically adjust interest rates based on changing conditions or to offer customized rates for specific user segments.

Some disclosed embodiments involve a compound Annual Percentage Rate (APR). The compound APR may refer to the annualized interest rate that represents the total cost of borrowing, including interest and fees, compounded over the course of a year. Unlike simple interest rates, which may be calculated only on the principal amount, compound APR considers the effect of compounding, where interest accumulates on both the original principal and any previously accrued interest. The compound APR may provide borrowers with a more accurate picture of the overall cost of a loan and allow lenders to present a transparent calculation of borrowing costs. Machine learning models within AUS may calculate and optimize compound APRs based on the applicant's profile.

Some disclosed embodiments involve payback. Payback may refer to the process of repaying or returning the principal and interest on a loan or financial obligation. Payback can also represent the time required for an investment to “pay back” its initial cost through profits or cash flows. The AUS may evaluate applicant data to determine the likelihood and timeline of successful payback. Machine learning models may predict potential risks or defaults by analyzing patterns in historical repayment data, thereby allowing the AUS to recommend appropriate payback terms. For lenders, understanding payback dynamics may be needed for managing cash flow, forecasting returns, and reducing the risk of non-performing loans. Automated underwriting systems may also monitor ongoing payback behavior, using real-time data to adjust credit limits, interest rates, or terms based on the borrower's repayment performance. These insights may enable the AUS to support financial decision-making that aligns with both borrower capacity and lender profitability.

Some disclosed embodiments involve realizing capital gain. Realizing capital gain refers to the act of selling an asset at a price higher than its original purchase cost, thereby converting its increased market value into actual profit. Capital gain represents the growth in value of an investment over time, and realizing it means that this gain may be no longer a paper increase but an actualized profit. Machine learning models in an AUS may analyze historical performance and user-defined financial goals to suggest optimal strategies for realizing capital gains.

Some disclosed embodiments involve an institution's employee payroll. An institution's employee payroll may refer to the total amount of compensation that an organization pays to its employees, including salaries, wages, bonuses, and benefits. Payroll also encompasses the administrative and accounting processes required to calculate, distribute, and manage these payments on a regular schedule. Understanding an institution's employee payroll may provide insights into the institution's financial position, helping both the institution with payroll management and lenders with risk assessment when considering business-related loans.

Some disclosed embodiments involve block chain technology. Block chain technology may refer to a decentralized, distributed ledger system that records transactions across multiple computers in a way that ensures transparency, security, and immutability. Each transaction may be stored in a “block,” and these blocks may be linked in a sequential “chain,” making it nearly impossible to alter any information retroactively without consensus from the network. Blockchain's structure and security features may be applied to enhance trust, transparency, and data integrity. Blockchain technology may enhance data security and transparency, making the underwriting process more trustworthy and efficient. Blockchain may be used to store and verify sensitive information, such as financial transactions, applicant histories, and contract terms. By ensuring data immutability, blockchain may prevent fraudulent claims or misrepresentations within AUS, as any change in applicant data or transaction history would be transparent and require consensus.

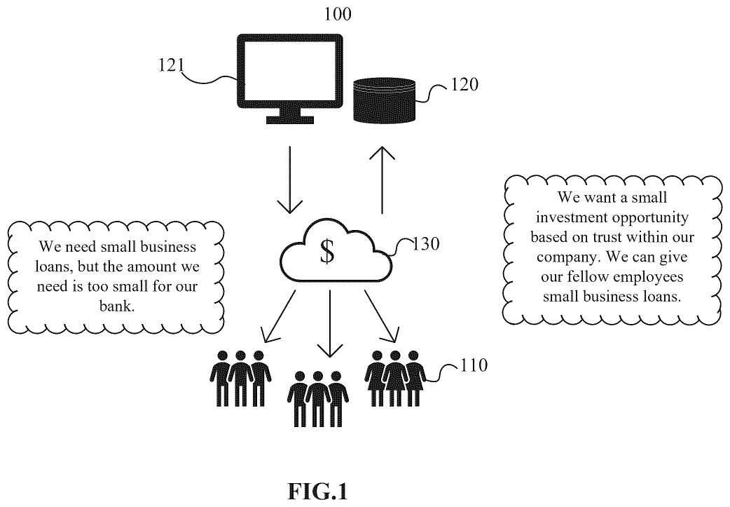

FIG. 1 is a diagram of an exemplary system for performing an automatic application processing, consistent with disclosed embodiments. System environment 100 may include one or more users 110, one or more computing devices 121, and one or more databases 120, as shown in FIG. 1.

The various components of system 100 may communicate over a network 130. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 100 is shown as a network-based environment, it may be understood that in some embodiments, one or more aspects of the disclosed systems and methods may also be used in a localized system, with one or more of the components communicating directly with each other.

Computing device 121 may include any form of remote computing device configured to receive, store, and transmit data. For instance, computing device 121 may be a server configured to store files accessible through a network (e.g., a web server, application server, virtualized server, etc.). In some other embodiments, the computing device 121 may also be configured to process batch-computation requested by user 110 through a network.

Computing device 121 may contain a processor that may take the form of, but may not be limited to, one or more integrated circuits (IC), including application-specific integrated circuits (ASIC), microchips, microcontrollers, microprocessors, embedded processors, all or part of a central processing unit (CPU), graphics processing unit (GPU), digital signal processor (DSP), field-programmable gate array (FPGA), server, virtual server, system on an chip (SOC) or other circuits suitable for executing instructions or performing logic operations. Furthermore, according to some embodiments, the processor may be from the family of processors manufactured by Intel®, AMD®, Qualcomm®, Apple®, NVIDIA®, or the like. The processor may also be based on the ARM architecture, a mobile processor, or a graphics processing unit, etc. The disclosed embodiments may not be limited to any type of processor configured in computing device 121.

Computing device 121 may interact with a database 120, for instance, a Relational Database (RDBMS) to store user login information. Database 120 may be included on a volatile or non-volatile, magnetic, semiconductor, tape, optical, removable, non-removable, or other type of storage device or tangible or non-transitory computer-readable medium. Database 120 may also be part of computing device 121 or separate from computing device 121. When database 120 is not part of computing device 121, computing device 121 may exchange data with database 120 via a communication link. Database 120 may include one or more memory devices that store data and instructions used to perform one or more features of the disclosed embodiments. Database 120 may include any suitable databases, ranging from small databases hosted on a working station to large databases distributed among data centers. Database 120 may also include any combination of one or more databases controlled by memory controller devices (e.g., server(s), etc.) or software. For instance, database 120 may include document management systems, Microsoft SQL™ databases, SharePoint™ databases, Oracle™ databases, Sybase™ databases, other relational databases, or non-relational databases, such as mongo and others. Although one database 120 is shown in FIG. 1, system environment 100 may include one or more databases 120, which may be used to store various types of information associated with customers of a financial institution.

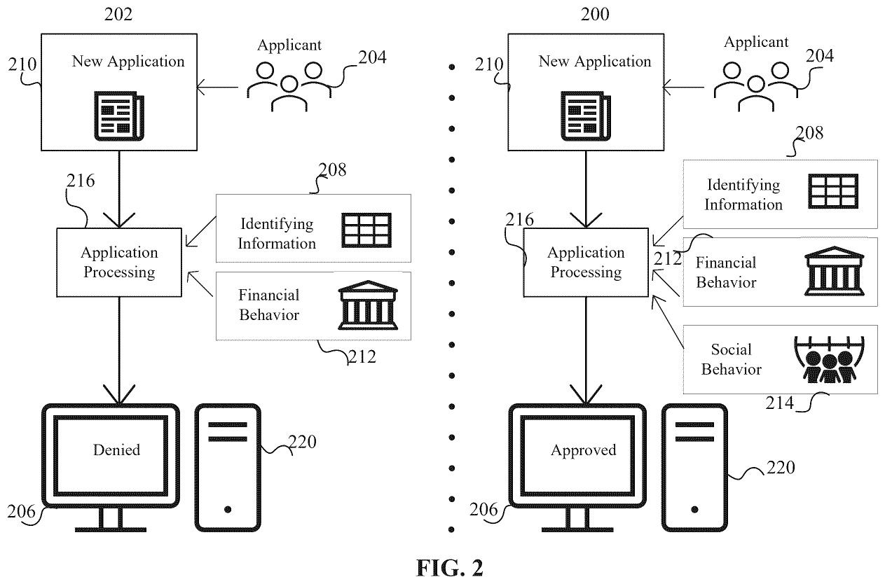

FIG. 2 is a block diagram showing a comparison of system 200 and system 202. System architecture may include a computing device 206, consistent with the disclosed embodiments. As described above, computing device 206 may be one or more devices configured to allow data to be received from applicant 204 (e.g., a server) and there may include one or more dedicated processors and/or memories. For instance, computing device 206 may include a processor 220. Computing device 206 may include a screen for displaying communications to an applicant 204 and user. In some embodiments computing device 206 may include a touch screen. Computing device 206 may include other components known in the art for interacting with a user. Computing device 206 may also include one or more digital and/or analog devices that allow a user to interact with system 202 and system 200, such as touch-sensitive area, keyboard, buttons, or microphones.

Computing device 206 may include one or more storage devices configured to store instructions used by a processor 220 to perform functions related to computing device 206. The disclosed embodiments may not be limited to particular software programs or devices configured to perform dedicated tasks. For instance, computing device 206 may store a single program, such as a user-level application, configured to perform the functions associated with the disclosed embodiments or may include multiple software programs. Additionally, the processor 220 may, in some embodiments, execute one or more programs (or portions thereof) remotely located from computing device 206. Furthermore, computing device 206 may include one or more storage devices configured to store data for use by the programs. Computing device 206 may include, but is not limited to a hard drive, a solid-state drive, a CD-ROM drive, a peripheral storage device (e.g., an external hard drive, a USB drive, etc.), a network drive, a cloud storage device, or any other storage device.

In system 202, the processor 220 may receive a new application 210 including identifying information 208 and application data from applicants 204. Identifying information 208 may include the applicant's name, social security number, business tax number, and the like. Identifying information 208 may be stored in a database such as database 120 for further analysis. The processor 220 may fetch data related to financial behavior 212 of the applicant. The financial behavior data may include credit score, payment history, demographic information, income to debt ratio and alike from any type of available databases. The identifying information 208 and financial behavior 212 may be aggregated into database 120.

The processor 220 may process an application using the identifying information 208, demographic information, and financial data 212 aggregated in database 120. The underwriting decision may be made based on the analysis of this information to categorize a degree of uncertainty related to each application. For instance, an insurance application may be received from applicant 204, and the applicant's financial behavior 212, as well as demographic information associated with applicant 204, may be aggregated into the application data. A decision may be made based on the demographic information and financial behavior 212 of the applicant. For instance, a business owner may apply for liability insurance for their small business. System 202 may collect the demographic and financial information from available sources and evaluate the degree of uncertainty of the application for future loss. The application may be denied for premium insurance rate as the business may be recently established and financial information may not be positive.

Meanwhile, some disclosed embodiments of system 200 may involve the processor 220 may, execute processing application utilizing the identifying information 208, demographic information, financial behavior 212, and social behavior 214 data aggregated in the database. Processor 220 may be configured to receive the identifying information 208 associated with a new application 206 from applicants 204. Processor 220 may be configured to obtain data related to the applicants' 204 social behavior 214 and store the data in a database such as database 120. Demographic, financial behavior 212, and social behavior 214 data may be aggregated into the database for application processing 216. Application processing 216 may be configured to process and analyze the different types of data sets related to the applications. Once the applications are processed by processor 220, they may be displayed for the users to select the desired application. Processor 220 may be configured to present a group of applications to a user based on the user's interest or the historical data related to the user's financial decision.

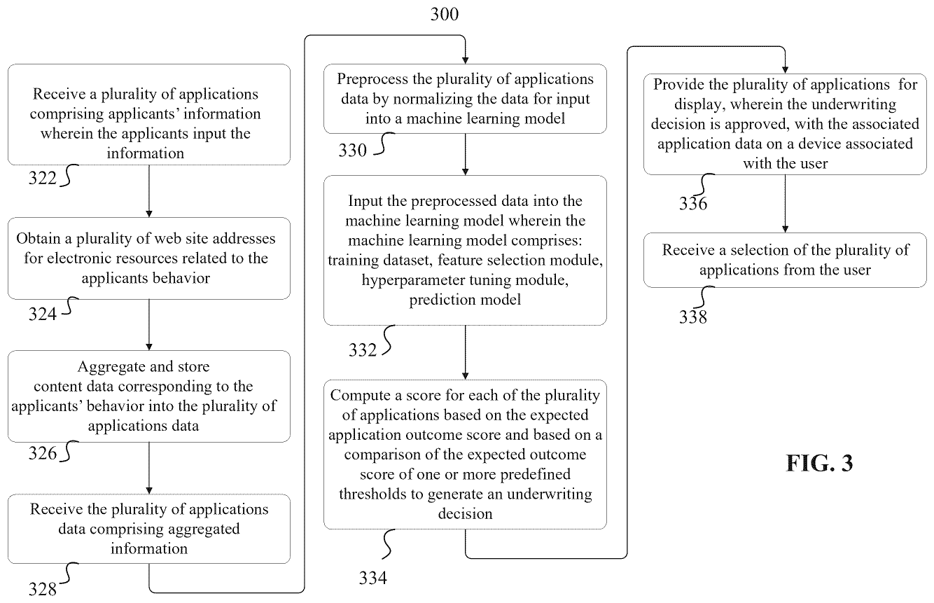

FIG. 3 is a flowchart of an exemplary embodiment for performing an automated crowdsourced investment process, consistent with disclosed embodiments. Process 300 may be performed by at least one processing device of a computing device, such as processor 220, as described above. Further, process 300 is not necessarily limited to the steps shown in FIG. 3. A user, in the context of the present disclosure, refers to a legally authorized person who has access to the system hosted by any financial institution.

At step 322, process 300 may include receiving a plurality of applications comprising applicants' information, wherein the applicants input the information. For instance, process 300 may provide the applicants' information through a web application user interface (UI) page, which may be displayed on a computing device as described with respect to FIG. 1. In some embodiments, providing such information may further include fetching the corresponding information from different databases, such as database 120.

At step 324, process 300 may involve obtaining a plurality of website addresses for electronic resources related to the applicants' behavior. For instance, if an applicant is a businessowner, a list of website addresses that contain reviews of the business and its industry may be obtained by the processor. Data on the applicant's social behavior may be obtained from public platforms that include user generated content. For instance, a public platform that contains reviews of the business may provide data on the reputation of the business and its marketing and success trajectory.

In some embodiments, at step 326, process 300 may include aggregating and storing content data corresponding to the applicants' behavior into the plurality of applications data. For instance, the system may fetch the clients' feedback on the business seeking a loan. The feedback may be aggregated and stored in a database, such as database 120. Processor 220 may be configured to receive the plurality of applications data including aggregated information at step 328. The processor 220 at step 330 may also be configured to preprocess the plurality of applications data by normalizing the data for input into a machine learning model, using methods described herein. In some embodiments, the feedback on the business applying for a loan may be of different types, such as text and images. The aggregated data stored in the database 120 may be preprocessed by translating all the text data into one language and remove duplicate or meaningless words in the text data, according to methods described herein.

In some embodiments, at step 332, process 300 may input the preprocessed data into a machine learning model. The machine learning model may include a training dataset, feature selection module, hyperparameter tuning module, and prediction model. As described herein, the training dataset may include applications data, underwriting decisions, financial gain and user-provided feedback based on a selection of previously approved applications. The training dataset may contain historical applications data representing applications that were previously evaluated and selected by the user. The training dataset may also incorporate user-provided feedback on the outcomes of the applications. For instance, a loan application approved by the underwriting system and chosen by a user for investment may generate feedback on whether the financial return aligned with the user's expectations and interests. This feedback, combined with historical application data, may be used to train the machine learning model to predict application outcomes, optimizing for scenarios where user satisfaction is maximized.

In some embodiments, process 300 may proceed with a machine learning model that incorporates a feature selection module as a component. The feature selection module may be designed to identify and prioritize the most relevant features from the preprocessed data that contribute to the model's predictive accuracy. By reducing the dimensionality of the input data and eliminating irrelevant or redundant features, the feature selection module may enhance the efficiency and performance of the machine learning model. For instance, in the context of underwriting applications, the feature selection module may prioritize attributes such as loan-to-value ratio, positive company reputation, and reliable behavior of the applicant. This prioritization may ensure that the model focuses on the most informative data points, ultimately enabling more precise and reliable predictions. The integration of the feature selection module may optimize the computational resources required for training and improve the interpretability and biases sf the machine learning model by highlighting the factors that drive underwriting decisions.

In some embodiments, process 300 may advance with a machine learning model that includes a hyperparameter tuning module as an essential component. The hyperparameter module may optimize the hyperparameters of the machine learning model to improve the machine learning module's predictive performance and accuracy. Hyperparameters may be preset configurations that guide the model's learning process, such as the learning rate, the number of layers in a neural network, or the regularization strength. The hyperparameter tuning module may iteratively adjust these settings based on predefined search strategies, such as grid search or random search, or more advanced techniques like Bayesian optimization. For example, in underwriting applications, the module may optimize the depth of a decision tree or the number of neurons in a neural network to accurately predict loan default risk.

In some embodiments, process 300 may advance with a machine learning model that may include a prediction module. The prediction module may be responsible for generating outcomes based on the trained model and input data. After processing the data through feature selection, hyperparameter tuning, and training phases, the prediction module may use the model's learned patterns to provide accurate and actionable decisions. For instance, in the context of underwriting, the prediction module may evaluate new loan applications to determine whether they are likely to meet the underwriting criteria. The prediction module may predict the likelihood of repayment and potential financial gain.

At step 334, process 300 may compute a score for each of the plurality of applications based on the expected application outcome score and based on a comparison of the expected outcome score of one or more predefined thresholds to generate an underwriting decision. This scoring may quantify the suitability of each application based on specific criteria defined by the underwriting model. For instance, in a loan underwriting system, the expected outcome score may be calculated using factors such as the applicant's comprehensive social and financial behavior profile. These scores may be compared to predefined thresholds-such as a minimum acceptable uncertainty level or a target profitability margin—to classify applications as approved or rejected.

In some embodiments, at step 336, the processor 220 may be configured to provide the plurality of applications for display with the associated application data on a device associated with the user when the underwriting decision is approved. This step may facilitate access to and review of the approved applications and their corresponding details, streamlining the decision-making process. For instance, in a loan underwriting system, after a batch of applications is evaluated, the processor 220 may display a list of approved loans on a user's dashboard, including key details such as the applicant's name, loan amount, interest rate, and repayment terms. This presentation enables users to make informed follow-up decisions, such as allocating funds or initiating contract approvals.

At step 338, process 300 may receive a selection of the plurality of applications from the user. Receiving the selection may involve receiving an input from the user associated with the selection, through the user interface. In some embodiments, payment may be processed according to the selected application according to methods disclosed herein.

In some embodiments the processor 220 may be further configured to process a payment for the selection applications. In some embodiments, blockchain technology may be used to link or connect various accounts and their corresponding transactions in a secure and transparent manner. Blockchain technology may be utilized to secure accounts, as described herein. Blockchain technology may be employed to link or connect various accounts and their corresponding transactions. By leveraging blockchain, the system may create an immutable ledger that records all payment activities, ensuring that each transaction is traceable and protected against tampering. For instance, in the context of a loan underwriting system, blockchain may be used to facilitate the disbursement of approved loan amounts to applicants while maintaining a secure and auditable record of the transaction for both the user and the applicant. Configurable hardware components, such as those found in Field-Programmable Gate Arrays (FPGAs), or Application-Specific Integrated Circuits (ASICs) may be utilized to enhance performance and efficiency of blockchain technology. For instance, FPGAs may contain configurable logic blocks (CLB), which may be used to support blockchain. The use of CLBs may accelerate the validation and processing of transactions because a developer using CLBs can connect and configure blocks, as well as reconfigure blocks with new variables and other changes as needed. The use of CLBs may further ensure that the blockchain network operates smoothly and swiftly by facilitating parallel computing used in blockchain network operations. Similarly, ASICs may be custom-designed for application-specific tasks, such as blockchain network operations. ASICs allow several blockchain operations to be consolidated into a single chip, which may make chips cheaper and easier to assemble. In some embodiments, one or more processors may initiate electronic transactions directing gained or accumulated funds to a designated account, in accordance with one or more rule sets such as regulations established by the Federal Deposit Insurance Corporation. In some embodiments, options may be provided to transfer funds into one or more accounts such as, for instance, a checking and/or savings account, or to pay down an existing loan.

In some embodiments, blockchain technology may allow linking a user account to an investment account that provides a real time execution of contract code. This functionality may provide visibility to all users. Blockchain technology may enable the seamless linking of a user account to an investment account, providing the capability for real-time execution of contract code. This integration may allow for automated and secure execution of predefined contractual terms, ensuring that transactions are processed without manual intervention. For instance, in an underwriting system, once an investment application is approved, blockchain technology may facilitate the direct transfer of funds from the user's account to the investment account, activating the investment immediately. A smart contract associated with the blockchain may automatically enforce one or more terms of the investment, such as distributing returns or tracking performance, without requiring additional user action.

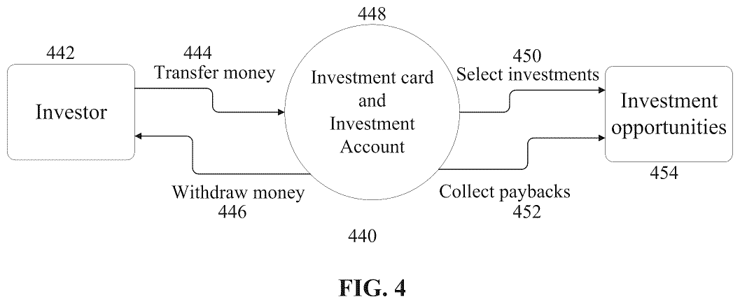

FIG. 4 shows an exemplary embodiment of how funds may be transferred, consistent with disclosed embodiments. System 440 includes an investor 442, a transfer money step 444, a withdraw money step 446, an investment card and investment account 448, a select investments step 450, a collect paybacks step 452, and investment opportunities 454.

In some embodiments, investor 442 may be a user of any kind who has legally registered as a user of the system disclosed herein and has access to the system. In some embodiments, investor 442 may be a financial institution employee. In some other embodiments, investor 442 may be personnel from an organization using the system. In other embodiments, investor 442 may be an external client of a financial institution.

Investment card and investment account 448 may be a special type of card and commercial bank account that aligns with Federal Deposit Insurance Corporation (FDIC) requirements such that investment card and investment account 448 allows tracking of funds into and out of the account. In some embodiments an investment card may be a physical card. The investment card may provide ease to transfer and retain funds. In some embodiments, the investment account may be the same as the bank account for investor 442.

In some embodiments, investment opportunities 454 may refer to a plurality of applications investor 442 can select from. Investment opportunities 454 may include bonds, stocks, small-loans, ETF, and any combination of other applications as it to be understood in the art. In some embodiments, investment opportunities 454 may include small loans issued by local business owner. The relevant information of investment opportunities 454 may be stored in database 120. In some embodiments, the relevant information, such as starting amount, interest rate, expected return, may be stored in one database 120. In other embodiments, that information may be stored into different database to improve run-time execution efficiency.

At select investments step 450, investor 442 may select one or more investment opportunities 454 and relate the one or more investment opportunities 454 to investment card and investment account 448. Selection of the one or more investment opportunities 454 may be performed according to methods disclosed herein.

At transfer money step 444, investor 442 may transfer funds from their bank account into a separate investment card or investment account. For instance, at transfer money step 444, investor 442 may link their bank account that is already set up to receive a direct deposit, to the investment account. For instance, the investment card may provide capability to cap spending limits. In other embodiments, investor 442 may manually transfer funds from their personal account to their investment account.

At collect paybacks step 452, system 440 may calculate and collect all the paybacks from the applications selected by investor 442. In some embodiments, the number of dividends may be calculated based on the specified information of the opportunity. In other embodiments, the specified dividends amount may be shared across multiple investors 442, and the allocation of dividends may be further based on the portion that each investor 442 spent.

At withdraw money step 446, investor 442 may select a certain amount of money to withdraw from the investment account to their regular bank account. In some embodiments, funds may be withdrawn from an automated teller machine. In some embodiments, there may be a limit on the maximum amount that can be withdrawn. In other embodiments, there may be a limit on the maximum on the total amount that can be withdrawn within a specific period of time.

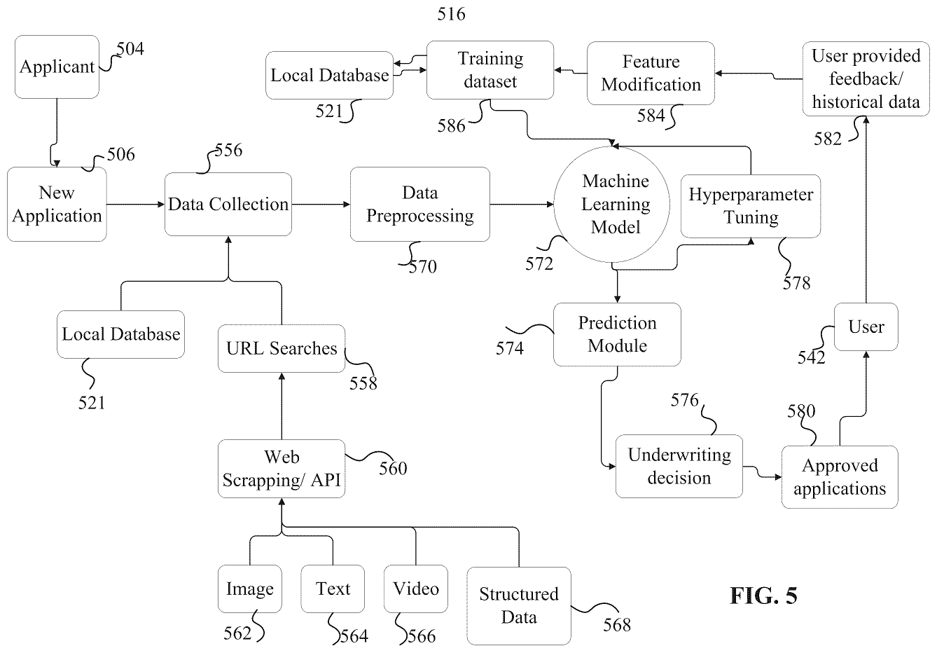

FIG. 5 is a block diagram of an exemplary application processing system 516 for generating underwriting decisions. Executable code with instructions for causing one or more processors to perform operations set forth in the steps in FIG. 5 may be stored in a local database 521. Operations may be performed based on instructions executed by, for example, at least one processor such as processor 220 of FIG. 2. In some embodiments, the application processing system 516 may include new applications 506 upon inputting information by the applicants 504. The application processing system 516 may include new applications 506, data collection 556, local database 521, URL searches 558, web scrapping/API 560, data types such as image 562, text 564, video 566, structured data 568, data preprocessing 570, machine learning model 572, prediction module 574, underwriting decision generation 576, hyperparameter tuning 578, approved applications 580, user 542, user-provided feedback 582, feature modification module 584, training data set 586, local database 521, hyperparameter tuning model 578, prediction module 574.

New applications 506 may refer to qualified applications that may not be currently available to a user, such as user 542, but that may be available in the future. Once new applications 506 may be added to the pool of applications with the information that applicant 504 provided, the processor 220 may obtain further information on the applicant's 504 behavior. In some embodiments, data collection 556 may include fetching data from one or more local databases 521 that may contain information such as demographics. Data collection 556 may include fetching data by searching electronic resources through their URL, as shown in URL searches module 558. It may involve web scrapping or API module 560. For instance, data collection 556 from public platforms, such as social media, may involve gathering publicly available information that reflects the applicant's social behavior, interests, and interactions. The collected data may include various data types such as posts, comments, likes, shares, and multimedia content that an individual has publicly shared on platforms like Facebook, Twitter, LinkedIn, or Instagram. For instance, an applicant's frequent posts about financial responsibility or participation in professional development groups may indicate traits such as reliability and ambition. Conversely, patterns of risky behavior, such as sharing content related to irresponsible spending or illegal activities, could raise red flags about the applicant's reliability or trustworthiness.

The application processing system 516 may involve data preprocessing. As data collection involves gathering various data types, preprocessing data may be intended to normalize and standardize the data to be processed by the machine learning model. The application processing system 516 may include machine learning model 572 configured to predict an outcome of the new application 506 of a financial product based on the analysis of the financial 212 and social behavior 214 of the applicant 504 and economic conditions. Training datasets 586 may include historical data from previously evaluated applications, the user's 542 activities, feedback, and financial outcome. Training datasets 586 may also include a group of features with their corresponding weight stored in the local database 521. The feature modification module 584 may be configured to generate a new batch of features and analyze the previous and new features set to find the optimum features set and its corresponding weight. The new features set may be generated based on the user-provided feedback 582. In some embodiments, the machine learning models 572 may use surveys to gauge users' 542 feedback on the application options. In some embodiments, the machine learning 572 functionality may help users 542 to understand appropriate timing of the application and expected return on investment.

The machine learning model 572 may include hyperparameter tuning module 578. The hyperparameter tuning module 578 may test and analyze different hyperparameters sets to find the optimum learning setting. Finding the optimum learning setting may improve the prediction accuracy of the applications and user satisfaction across the system. The machine learning model 572 may dynamically be trained upon updating training dataset 586. The trained machine learning model 572 may receive the new application 506, which may include aggregated preprocessed data. The machine learning model 572 may predict the outcome of the new application 506 and compute a score based on the predetermined threshold using prediction module 574. The predetermined threshold may be customized for a user 542 or may be the same across the platform for all the users 542. Based on the computed score, an underwriting decision 576 may be generated. The applications that receive label of approved 580 may be displayed for the users 542 that have aligned interest with the application demographic information.

Suggested application may refer to the approved application 580 presented to user 542 in step 336, as described with respect to FIG. 3. Suggested applications may also refer to a different set of opportunities and may include new application 506. In some embodiments, when user 542 indicates they would like greater selection of application, application processing system 516 may predict another list of applications based on machine learning models 572. In some embodiments, the list of suggested applications may only contain the applications predicted by the machine learning models 572. In other embodiments, the list of suggested applications may also include other applications, consistent with disclosed embodiments.

After a user 542 selects certain applications, the data may be collected and used to update user historical data. Information such as the applications present but not selected, corresponding labels, and application amount may be considered for use in updating the user historical data. In some embodiments, this historical data may be cleaned on a periodic basis. For instance, the system may only keep the user historical data for the most recent year. In some embodiments, the system may update the machine learning models 572 using user historical data. In some embodiments, this may further include retraining using a processor, such as processor 220.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. For instance, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims may be to be interpreted broadly based on the language employed in the claims and not limited to examples described in the present specification or during the prosecution of the application, which examples may be to be construed as nonexclusive. Further, the steps of the disclosed methods can be modified in any manner, including reordering steps and/or inserting or deleting steps.

The features and advantages of the disclosure may be apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

According to some embodiments, the operations, techniques, and/or components described herein can be implemented by a device or system, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that may be programmed to perform the operations, techniques and/or components described herein, or can include one or more hardware processors programmed to perform such features of the present disclosure pursuant to program instructions in firmware, non-transitory computer readable medium, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that can incorporate hard-wired and/or program logic to implement the techniques and other features of the present disclosure.

The one or more special-purpose computing devices can be generally controlled and coordinated by operating system software, such as iOS, ANDROID, BLACKBERRY, Chrome OS, WINDOWS XP, WINDOWS VISTA, WINDOWS 7, WINDOWS 8, WINDOWS Server, WINDOWS CE, UNIX, LINUX, SUNOS, SOLARIS, VXWORKS, or other compatible operating systems. In other embodiments, the computing device can be controlled by a proprietary operating system. Operating systems can control and schedule computer processes for execution, perform non-transitory computer readable medium management, provide file system, networking, I/O services, and provide a user interface functionality, such as a graphical user interface (“GUI”), among other things.

Furthermore, although aspects of the disclosed embodiments may be described as being associated with data stored in non-transitory computer readable medium and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments may be not limited to the above described examples, but instead may be defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims may be to be interpreted broadly based on the language employed in the claims and not limited to examples described in the present specification or during the prosecution of the application, which examples may be construed as non-exclusive. Further, the steps of the disclosed methods can be modified in any manner, including by reordering steps or inserting or deleting steps.

It is intended, therefore, that the specification and examples be considered as example only, with a true scope and spirit being indicated by the following claims and their full scope of equivalents.

What is claimed is:

1. A system for automating processing of a products application, comprising:
a database storing a set of instructions; and
a processor configured to execute the set of instructions to:
receive the products application, the products application including application data associated with an applicant;
obtain a plurality of website addresses for electronic resources related to behavior associated with the applicant;
aggregate content data corresponding to the behavior into the application data;
preprocess the application data into preprocessed data by normalizing the application data for input into a machine learning model;
input the preprocessed data into the machine learning model, the machine learning model including:
a training dataset including data associated with a historical application, an underwriting decision associated with the historical application, financial gain data associated with the historical application, and user-provided feedback associated with the historical application;
a feature selection module configured to:
receive a plurality of candidate features associated with the behavior;
analyze the plurality of candidate features to determine a feature weight indicating the predictive value of each feature of the plurality of candidate features with respect to a target outcome; and
select, based on the feature weight, a subset of features;
a hyperparameter tuning module configured to:
automatically generate a set of hyperparameters;
define a search space of candidate hyperparameters and associated ranges based on one or more model performance requirements and the training dataset; and
iteratively adjust the hyperparameters using a tuning strategy; and
a prediction model configured to compute an expected application outcome score based on the training dataset, the feature selection module, and the hyperparameter tuning module;
generate an underwriting decision based on the expected application outcome score, the underwriting decision being one chosen from the set of rejected, conditional, and approved;
if the underwriting decision is approved, provide the products application and application data for display on a device associated with a user; and
receive a selection associated with the products application from the device associated with the user.

2. The system of claim 1, wherein the processor is further configured to execute the instructions to:
process a payment associated with the selection through an investment card and an investment account;
collect a pre-calculated payback associated with the selection; and
return the pre-calculated payback to an account associated with the user.

3. The system of claim 1, wherein the feature selection module is further configured to dynamically modify the candidate features based on the user-provided feedback.

4. The system of claim 3, wherein the dynamic modification occurs after the selection.

5. The system of claim 1, wherein the target outcome is maximizing a satisfaction score associated with the user, the satisfaction score being calculated based on the selection.

6. The system of claim 1, wherein the user is a plurality of users.

7. The system of claim 1, wherein the analysis of candidate features includes one or more of a permutation importance, SHAP (SHapley Additive exPlanations), and LIME (Local Interpretable Model-agnostic Explanations).

8. The system of claim 1, wherein the content data is collected from the plurality of website addresses by a web scraping module configured to:
extract raw content data from the plurality of website addresses by parsing the content of web pages associated with the plurality of website addresses, the raw content data including text, images, or metadata; and
format the raw content data into the content data, such that the content data is suitable for processing by the processor.

9. The system of claim 1, wherein the content data is collected from the plurality of website addresses by an Application Programming Interface (API) configured to:
access raw content data from an external source by connecting to the API, the raw content data including text, numerical values, or media content; and
format the raw content data into the content data, such that the content data is suitable for processing by the processor.

10. The system of claim 1, wherein the application data includes an image; and the preprocessing includes resizing, normalizing, and standardizing image dimensions associated with the image and pixel values associated with the image to ensure consistency; applying filtering techniques to enhance quality of the image; and converting the image into a format compatible with the feature selection module.

11. The system of claim 1, wherein the application data includes a video; and the preprocessing includes segmenting the video into a plurality of frames at predefined intervals to extract representative visual content while reducing data volume; resizing, normalizing, and standardizing the plurality of frames to ensure consistency; applying enhancement techniques to the plurality of frames; and converting the plurality of frames into a format compatible with the feature selection module.

12. The system of claim 1, wherein the application data includes text; and the preprocessing includes removing one or more unwanted characters, including special symbols, emojis, and hyperlinks, for standardization; performing stop-word removal; stemming or lemmatization to reduce text complexity; and converting the text into a format compatible with the feature selection module.

13. The system of claim 1, wherein the application data includes text data; and the machine learning model is further configured to perform natural language processing to understand the meaning of the text data.

14. The system of claim 1, wherein the application data includes multilingual application data; and the machine learning model is further configured to process the multilingual application data.

15. The system of claim 1, wherein adjusting the hyperparameters is based on the underwriting decision and a type of financial product associated with the selection.

16. The system of claim 1, wherein the plurality of website addresses for electronic resources includes at least one chosen from the set of social media platforms, forums, and other user-generated content platforms that contain publicly available content including posts, comments, images, and videos.

17. The system of claim 1, wherein the plurality of website addresses for electronic resources includes at least one privately owned external database, wherein data collection associated with the at least one privately owned external database is in accordance with an applicable data usage agreement.

18. The system of claim 1, wherein the electronic resources include one or more chosen from the set of: criminal history, education history, driving records, civil court records, and professional licenses.

19. The system of claim 1, wherein the hyperparameter tuning module is further configured to increase a user satisfaction score associated with the expected application outcome score.

20. The system of claim 1, wherein the prediction model includes one or more of a decision tree model, a support vector machine, and a deep learning model.

21. The system of claim 1, wherein the application data includes a desired interest rate.

22. The system of claim 2, wherein the investment card is associated with a spending limit.

23. The system of claim 2, wherein the return recurs for a predetermined period of time.

24. The system of claim 2, wherein returning the pre-calculated payback includes distributing a proportional amount based on a funding request associated with the products application.

25. The system of claim 2, wherein the return occurs automatically when the products application results in a capital gain.

26. The system of claim 2, wherein the user is an employee associated with an institution; and the investment account is created from an employee payroll associated with the institution.

27. The system of claim 2, wherein the processing of the payment uses blockchain technology.

28. A computer-implemented method for automating processing of a products application, comprising:
receiving the products application, the products application including application data associated with an applicant;
obtaining a plurality of website addresses for electronic resources related to behavior associated with the applicant;
aggregating content data corresponding to the behavior into the application data;
preprocessing the application data into preprocessed data by normalizing the application data for input into a machine learning model;
inputting the preprocessed data into the machine learning model, the machine learning model including:
a training dataset including data associated with a historical application, an underwriting decision associated with the historical application, financial gain data associated with the historical application, and user-provided feedback associated with the historical application;
a feature selection module configured to:
receive a plurality of candidate features associated with the behavior;
analyze the plurality of candidate features to determine a feature weight indicating the predictive value of each feature of the plurality of candidate features with respect to a target outcome; and
select, based on the feature weight, a subset of features;
a hyperparameter tuning module configured to:
automatically generate a set of hyperparameters;
define a search space of candidate hyperparameters and associated ranges based on one or more model performance requirements and the training dataset; and
iteratively adjust the hyperparameters using a tuning strategy; and
a prediction model configured to compute an expected application outcome score based on the training dataset, the feature selection module, and the hyperparameter tuning module;
generate an underwriting decision based on the expected application outcome score, the underwriting decision being one chosen from the set of rejected, conditional, and approved;
if the underwriting decision is approved, provide the products application and application data for display on a device associated with a user; and
receive a selection associated with the products application from the device associated with the user.

29. The method of claim 28, wherein the method further comprises suggesting an timing for the selection based on a predicted financial gain associated with the products application.

30. The method of claim 28, wherein the machine learning model predicts a likelihood of selection associated with the products application, the likelihood of selection being based on interest data associated with the user and product application selection history data associated with the user.
